(19) United States
(12) Patent Application Publication
(10) Pub. No.: US 2022/0012387 A1
(43) Pub. Date: Jan. 13, 2022

(54) INFORMATION PROCESSING DEVICE, INFORMATION PROCESSING SYSTEM, INFORMATION PROCESSING METHOD, AND STORAGE MEDIUM

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventors: Masaru SUZUKI, Ota Tokyo (JP); Hayato GOTO, Kawasaki Kanagawa (JP); Kosuke TATSUMURA, Kawasaki Kanagawa (JP); Kotaro ENDO, Shinjuku Tokyo (JP); Yoshisato SAKAI, Kawasaki Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 17/487,161

(22) Filed: Sep. 28, 2021

Related U.S. Application Data
(63) Continuation of application No. PCT/JP2020/014156, filed on Mar. 27, 2020.

(30) Foreign Application Priority Data
Mar. 28, 2019 (JP) 2019-064587

(51) Int. Cl. G06F 30/20

(52) U.S. Cl. CPC G06F 30/20; G06F 2111/10

(57) ABSTRACT

An information processing device includes a storage unit and a processing circuit. The storage unit is configured to store a first variable and a second variable. The processing circuit is configured to update the first variable based on the second variable, which corresponds to the first variable, weight the first variable with a first coefficient and add the weighted first variable to the corresponding second variable, calculate a problem term using the plurality of first variables, add the problem term to the second variable, calculate a first correction term including a product of a constraint term and a second coefficient, add the first correction term to the second variable, and increase absolute values of the first coefficient and the second coefficient depending on the number of updates. The constraint term is based on a constraint condition and has the first variable as an argument.

### CROSS REFERENCE TO RELATED APPLICATIONS

This application is continuation application of International Application No. JP2020/014156, filed on Mar. 27, 2020, which claims priority to Japanese Patent Application No. 2019-064587, filed on Mar. 28, 2019, the entire contents of which are incorporated herein by reference.

### FIELD

Embodiments of the present invention relate to an information processing device, an information processing system, an information processing method, and a storage medium.

### BACKGROUND

A combinatorial optimization problem is a problem of selecting a combination most suitable for a purpose from a plurality of combinations. Mathematically, combinatorial optimization problems are attributed to problems for maximizing functions including a plurality of discrete variables, called “objective functions”, or minimizing the functions. Although combinatorial optimization problems are common problems in various fields including finance, logistics, transport, design, manufacture, and life science, it is not always possible to calculate an optimal solution due to so-called “combinatorial explosion” that the number of combinations increases in exponential orders of a problem size. In addition, it is difficult to even obtain an approximate solution close to the optimal solution in many cases.

Development of a technique for calculating a solution for the combinatorial optimization problem within a practical time is required in order to solve problems in each field and promote social innovation and progress in science and technology.

### BRIEF DESCRIPTION OF DRAWINGS

FIG. 1 is a diagram illustrating a configuration example of an information processing system.

FIG. 2 is a block diagram illustrating a configuration example of a management server.

FIG. 3 is a diagram illustrating an example of data stored in a storage unit of the management server.

FIG. 4 is a block diagram illustrating a configuration example of a calculation server.

FIG. 5 is a diagram illustrating an example of data stored in a storage of the calculation server.

FIG. 6 is a flowchart illustrating an example of processing in a case where a solution of a simulated bifurcation algorithm is calculated by time evolution.

FIG. 7 is a table illustrating an example of an equality constraint.

FIG. 8 is a table illustrating an example of an inequality constraint.

FIG. 9 is a table illustrating an example of the inequality constraint.

FIG. 10 is a flowchart illustrating an example of a solving process in an extended Hamiltonian including a first correction term.

FIG. 11 is a flowchart illustrating an example of a solving process in an extended Hamiltonian further including a second correction term.

FIG. 12 is a flowchart illustrating an example of a solving process in a case where a part of a process of updating a coefficient λₘ is skipped.

FIG. 13 is a diagram schematically illustrating an example of a multi-processor configuration.

FIG. 14 is a diagram schematically illustrating an example of a configuration using a GPU.

FIG. 15 is a flowchart illustrating an example of overall processing executed to solve a combinatorial optimization problem.

### DETAILED DESCRIPTION

According to one embodiment, an information processing device includes a storage unit and a processing circuit. The storage unit is configured to store a first variable which is an element of a first vector and a second variable which is an element of a second vector. The processing circuit is configured to update the first variable based on the second variable, which corresponds to the first variable; weight the first variable with a first coefficient and add the weighted first variable to the corresponding second variable; calculate a problem term using the plurality of first variables; add the problem term to the second variable; calculate a first correction term including a product of a constraint term and a second coefficient; add the first correction term to the second variable; and increase absolute values of the first coefficient and the second coefficient depending on the number of updates. The constraint term is based on a constraint condition and has the first variable as an argument.

Hereinafter, embodiments of the present invention will be described with reference to the drawings. In addition, the same components will be denoted by the same reference signs, and a description thereof will be omitted as appropriate.

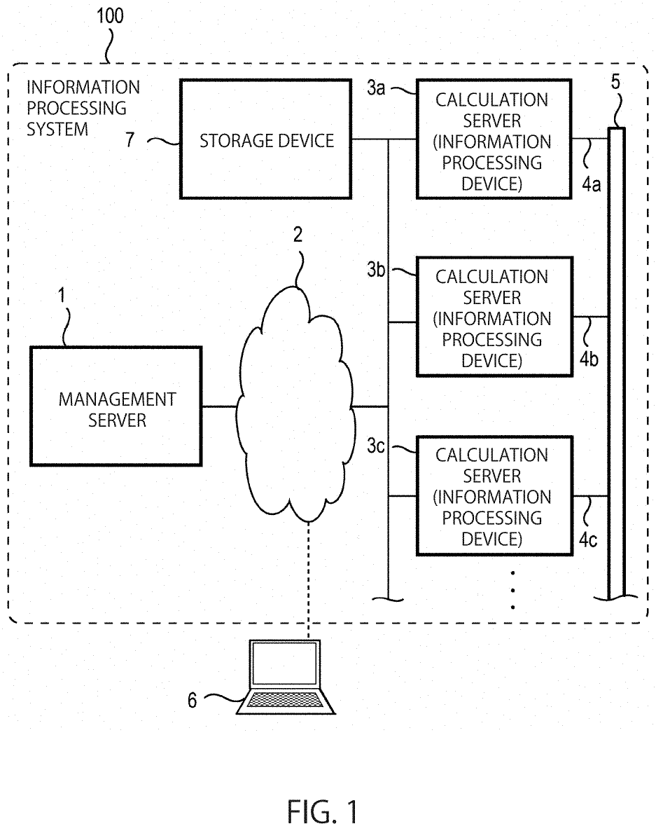

FIG. 1 is a block diagram illustrating a configuration example of an information processing system 100. The information processing system 100 of FIG. 1 includes a management server 1, a network 2, calculation servers (information processing devices) 3a to 3c, cables 4a to 4c, a switch 5, and a storage device 7. In addition, FIG. 1 illustrates a client terminal 6 that can communicate with the information processing system 100. The management server 1, the calculation servers 3a to 3c, the client terminal 6, and the storage device 7 can perform data communication with each other via the network 2. For example, the calculation servers 3a to 3c can store data in the storage device 7 and read data from the storage device 7. The network 2 is, for example, the Internet in which a plurality of computer networks are connected to each other. The network 2 can use a wired or wireless communication medium or a combination thereof. In addition, an example of a communication protocol used in the network 2 is TCP/IP, but a type of communication protocol is not particularly limited.

In addition, the calculation servers 3a to 3c are connected to the switch 5 via the cables 4a to 4c, respectively. The cables 4a to 4c and the switch 5 form interconnection between the calculation servers. The calculation servers 3a to 3c can also perform data communication with each other via the interconnection. The switch 5 is, for example, an Infiniband switch. The cables 4a to 4c are, for example, Infiniband cables. However, a wired LAN switch/cable may be used instead of the Infiniband switch/cable. Communication standards and communication protocols used in the cables 4a to 4c and the switch 5 are not particularly limited. Examples of the client terminal 6 include a notebook PC, a desktop PC, a smartphone, a tablet, and an in-vehicle terminal.

Parallel processing and/or distributed processing can be performed to solve a combinatorial optimization problem. Therefore, the calculation servers 3a to 3c and/or processors of the calculation servers 3a to 3c may share and execute some steps of calculation processes, or may execute similar calculation processes for different variables in parallel. For example, the management server 1 converts a combinatorial optimization problem input by a user into a format that can be processed by each calculation server, and controls the calculation server. Then, the management server 1 acquires calculation results from the respective calculation servers, and converts the aggregated calculation result into a solution of the combinatorial optimization problem. In this manner, the user can obtain the solution to the combinatorial optimization problem. It is assumed that the solution of the combinatorial optimization problem includes an optimal solution and an approximate solution close to the optimal solution.

FIG. 1 illustrates three calculation servers. However, the number of calculation servers included in the information processing system is not limited. In addition, the number of calculation servers used for solving the combinatorial optimization problem is not particularly limited. For example, the information processing system may include one calculation server. In addition, a combinatorial optimization problem may be solved using any one of a plurality of calculation servers included in the information processing system. In addition, the information processing system may include several hundred or more calculation servers. The calculation server may be a server installed in a data center or a desktop PC installed in an office. In addition, the calculation server may be a plurality of types of computers installed at different locations. A type of information processing device used as the calculation server is not particularly limited. For example, the calculation server may be a general-purpose computer, a dedicated electronic circuit, or a combination thereof.

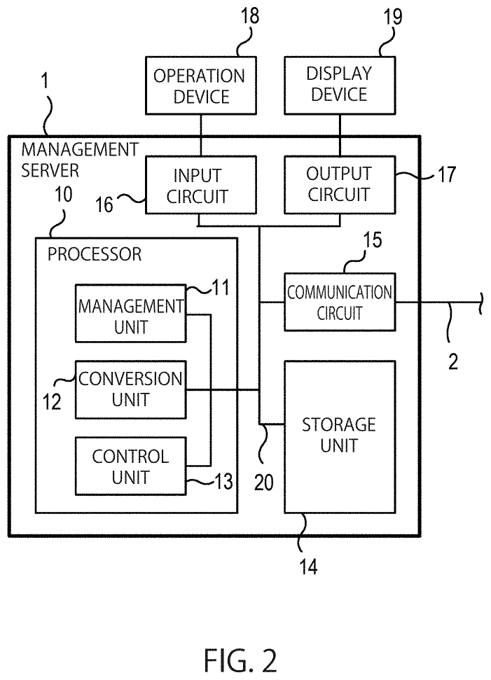

FIG. 2 is a block diagram illustrating a configuration example of the management server 1. The management server 1 of FIG. 2 is, for example, a computer including a central processing unit (CPU) and a memory. The management server 1 includes a processor 10, a storage unit 14, a communication circuit 15, an input circuit 16, and an output circuit 17. It is assumed that the processor 10, the storage unit 14, the communication circuit 15, the input circuit 16, and the output circuit 17 are connected to each other via a bus 20. The processor 10 includes a management unit 11, a conversion unit 12, and a control unit 13 as internal components.

The processor 10 is an electronic circuit that executes an operation and controls the management server 1. As the processor 10, for example, a CPU, a microprocessor, an ASIC, an FPGA, a PLD, or a combination thereof can be used. The management unit 11 provides an interface configured to operate the management server 1 via the client terminal 6 of the user. Examples of the interface provided by the management unit 11 include an API, a CLI, and a web page. For example, the user can input information of a combinatorial optimization problem via the management unit 11, and browse and/or download a calculated solution of the combinatorial optimization problem. The conversion unit 12 converts the combinatorial optimization problem into a format that can be processed by each calculation server. The control unit 13 transmits a control command to each calculation server. After the control unit 13 acquires calculation results from the respective calculation servers, the conversion unit 12 aggregates the plurality of calculation results and converts the aggregated result into a solution of the combinatorial optimization problem. In addition, the control unit 13 may designate a processing content to be executed by each calculation server or a processor in each server.

The storage unit 14 stores various types of data including a program of the management server 1, data necessary for execution of the program, and data generated by the program. Here, the program includes both an OS and an application. The storage unit 14 may be a volatile memory, a non-volatile memory, or a combination thereof. Examples of the volatile memory include a DRAM and an SRAM. Examples of the non-volatile memory include a NAND flash memory, a NOR flash memory, a ReRAM, or an MRAM. In addition, a hard disk, an optical disk, a magnetic tape, or an external storage device may be used as the storage unit 14.

The communication circuit 15 transmits and receives data to and from each device connected to the network 2. The communication circuit 15 is, for example, a network interface card (NIC) of a wired LAN. However, the communication circuit 15 may be another type of communication circuit such as a wireless LAN. The input circuit 16 implements data input with respect to the management server 1. It is assumed that the input circuit 16 includes, for example, a USB, PCI-Express, or the like as an external port. In the example of FIG. 2, an operation device 18 is connected to the input circuit 16. The operation device 18 is a device configured to input information to the management server 1. The operation device 18 is, for example, a keyboard, a mouse, a touch panel, a voice recognition device, or the like, but is not limited thereto. The output circuit 17 implements data output from the management server 1. It is assumed that the output circuit 17 includes HDMI, DisplayPort, or the like as an external port. In the example of FIG. 2, the display device 19 is connected to the output circuit 17. Examples of the display device 19 include a liquid crystal display (LCD), an organic electroluminescence (EL) display, and a projector, but are not limited thereto.

An administrator of the management server 1 can perform maintenance of the management server 1 using the operation device 18 and the display device 19. Note that the operation device 18 and the display device 19 may be incorporated in the management server 1. In addition, the operation device 18 and the display device 19 are not necessarily connected to the management server 1. For example, an administrator may perform maintenance of the management server 1 using a client terminal capable of communicating with the network 2.

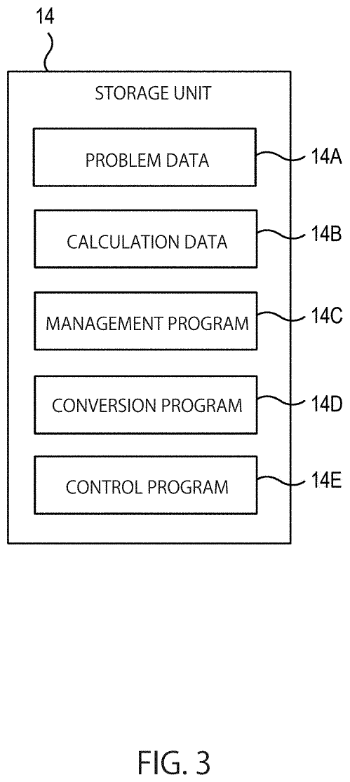

FIG. 3 illustrates an example of data stored in the storage unit 14 of the management server 1. The storage unit 14 of FIG. 3 stores problem data 14A, calculation data 14B, a management program 14C, a conversion program 14D, and a control program 14E. For example, the problem data 14A includes data of a combinatorial optimization problem. For example, the calculation data 14B includes a calculation result collected from each calculation server. For example, the management program 14C is a program that implements the above-described function of the management unit 11. For example, the conversion program 14D is a program that implements the above-described function of the conversion unit 12. For example, the control program 14E is a program that implements the above-described function of the control unit 13.

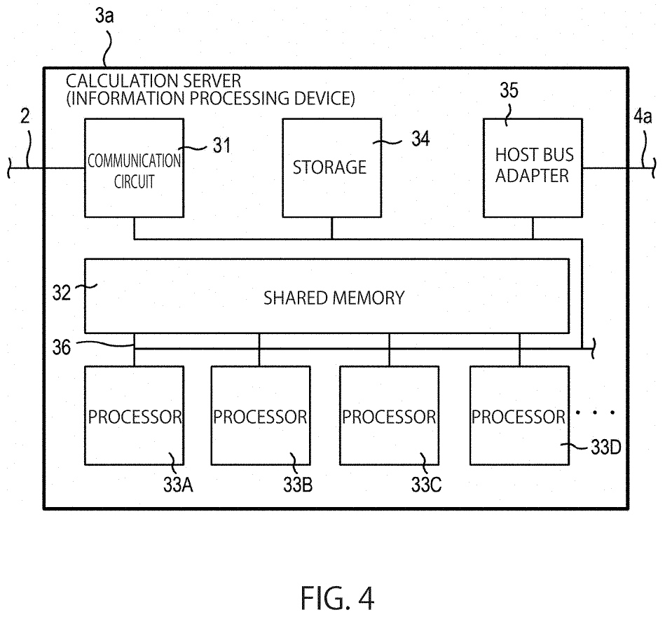

FIG. 4 is a block diagram illustrating a configuration example of the calculation server. FIG. 4 illustrates a configuration of the calculation server 3a as an example. The other calculation server may have a configuration similar to that of the calculation server 3a or may have a configuration different from that of the calculation server 3a. The calculation server 3a is, for example, an information processing device that performs calculation of a first vector and a second vector alone or in a shared manner with the other calculation server. In addition, at least one of the calculation servers may calculate a problem term between elements of the first vector. Here, the problem term may be calculated based on an Ising model to be described later. In addition, the problem term may include a many-body interaction to be described later.

For example, the first vector is a vector having a variable xᵢ (i=1, 2, . . . , N) as an element. For example, the second vector is a vector having a variable yᵢ (i=1, 2, . . . , N) as an element.

The calculation server 3a includes, for example, a communication circuit 31, a shared memory 32, processors 33A to 33D, a storage 34, and a host bus adapter 35. It is assumed that the communication circuit 31, the shared memory 32, the processors 33A to 33D, the storage 34, and the host bus adapter 35 are connected to each other via a bus 36.

The communication circuit 31 transmits and receives data to and from each device connected to the network 2. The communication circuit 31 is, for example, a network interface card (NIC) of a wired LAN. However, the communication circuit 31 may be another type of communication circuit such as a wireless LAN. The shared memory 32 is a memory accessible from the processors 33A to 33D. Examples of the shared memory 32 include a volatile memory such as a DRAM and an SRAM. However, another type of memory such as a non-volatile memory may be used as the shared memory 32. The shared memory 32 may be configured to store, for example, the element of the first vector and the element of the second vector. Here, the shared memory 32 and a storage 34 to be described later are examples of a storage unit of the information processing device. The processors 33A to 33D can share data via the shared memory 32. Note that all the memories of the calculation server 3a are not necessarily configured as shared memories. For example, some of the memories of the calculation server 3a may be configured as a local memory that can be accessed only by any processor.

The processors 33A to 33D are electronic circuits that execute calculation processes. The processor may be, for example, any of a central processing unit (CPU), a graphics processing unit (GPU), a field-programmable gate array (FPGA), and an application specific integrated circuit (ASIC), or a combination thereof. In addition, the processor may be a CPU core or a CPU thread. When the processor is the CPU, the number of sockets included in the calculation server 3a is not particularly limited. In addition, the processor may be connected to another component of the calculation server 3a via a bus such as PCI express.

In the example of FIG. 4, the calculation server includes four processors. However, the number of processors included in one calculation server may be different from this. For example, the number and/or types of processors implemented in the calculation server may be different.

For example, the information processing device is configured to repeatedly update the first vector which has a first variable xᵢ (i=1, 2, . . . , N) as an element and the second vector which has a second variable yᵢ (i=1, 2, . . . , N) corresponding to the first variable as an element. The storage unit of the information processing device may be configured to store a first variable which is an element of a first vector and a second variable which is an element of a second vector.

A processing circuit of the information processing device includes, for example, a processing circuit configured to update the first variable based on the corresponding second variable; weight the first variable with a first coefficient and add the weighted first variable to the corresponding second variable; calculate a problem term using the plurality of first variables; add the problem term to the second variable; calculate a first correction term including a product of a constraint term and a second coefficient; add the first correction term to the second variable; and increase absolute values of the first coefficient and the second coefficient depending on the number of updates. Here, the constraint term is based on a constraint function representing a constraint condition, and has the first variable as an argument. Here, the above-described processors 33A to 33D are examples of the processing circuit. In this manner, the information processing device may include a plurality of the processing circuits. In this case, the respective processing circuits may be configured to update at least a part of the first vector and at least a part of the second vector in parallel.

Hereinafter, a case where the first coefficient and the second coefficient are positive values, and the values of the first coefficient and the second coefficient increase depending on the number of updates will be described as an example. However, it is also possible to use a first coefficient and a second coefficient which are negative values by inverting signs of an algorithm to be presented hereinafter. In this case, the values of the first coefficient and the second coefficient can decrease depending on the number of updates. In either case, however, it can be said that the absolute values of the first coefficient and the second coefficient increase depending on the number of updates. Note that the problem term calculated by the processing circuit may be based on an Ising model. In addition, the problem term calculated by the processing circuit may include a many-body interaction.

Here, the case where the processing content is allocated in units of processors has been described as an example. However, a unit of a calculation resource in which the processing content is allocated is not limited. For example, the processing content may be allocated in units of calculators.

Hereinafter, components of the calculation server will be described with reference to FIG. 4 again.

The storage 34 stores various data including a program of the calculation server 3a, data necessary for executing the program, and data generated by the program. Here, the program includes both an OS and an application. The storage 34 may be configured to store, for example, the element of the first vector and the element of the second vector. The storage 34 may be a volatile memory, a non-volatile memory, or a combination thereof. Examples of the volatile memory include a DRAM and an SRAM. Examples of the non-volatile memory include a NAND flash memory, a NOR flash memory, a ReRAM, or an MRAM. In addition, a hard disk, an optical disk, a magnetic tape, or an external storage device may be used as the storage 34.

The host bus adapter 35 implements data communication between the calculation servers. The host bus adapter 35 is connected to the switch 5 via the cable 4a. The host bus adapter 35 is, for example, a host channel adaptor (HCA). The speed of parallel calculation processes can be improved by forming interconnection capable of achieving a high throughput using the host bus adapter 35, the cable 4a, and the switch 5.

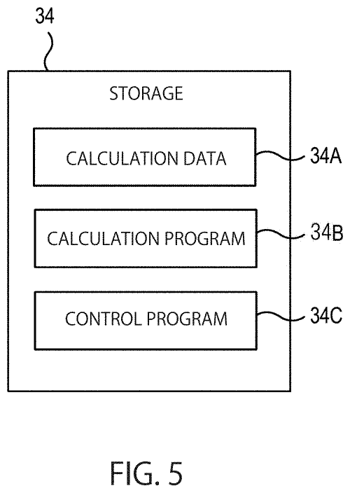

FIG. 5 illustrates an example of data stored in the storage of the calculation server. The storage 34 of FIG. 5 stores calculation data 34A, a calculation program 34B, and a control program 34C. The calculation data 34A includes data in the middle of calculation by the calculation server 3a or a calculation result. Note that at least a part of the calculation data 34A may be stored in a different storage hierarchy such as the shared memory 32, a cache of the processor, and a register of the processor. The calculation program 34B is a program that implements a calculation process in each processor and a process of storing data in the shared memory 32 and the storage 34 based on a predetermined algorithm. The control program 34C is a program that controls the calculation server 3a based on a command transmitted from the control unit 13 of the management server 1 and transmits a calculation result of the calculation server 3a to the management server 1.

Next, a technique related to solving a combinatorial optimization problem will be described. An example of the information processing device used to solve the combinatorial optimization problem is an Ising machine. The Ising machine refers to an information processing device that calculates the energy of a ground state of an Ising model. Hitherto, the Ising model has been mainly used as a model of a ferromagnet or a phase transition phenomenon in many cases. In recent years, however, the Ising model has been increasingly used as a model for solving a combinatorial optimization problem. The following Formula (1) represents the energy of the Ising model.

$$\begin{matrix}[ Formula 1 ] & \\ {E}_{Ising} = {\sum }_{i = 1}^{N} {h}_{i} {s}_{i} + \frac{1}{2} {\sum }_{i = 1}^{N} {\sum }_{j = 1}^{N} {J}_{i , j} {s}_{i} {s}_{j} & ( 1 )\end{matrix}$$

Here, sᵢ and sⱼ are spins, and the spins are binary variables each having a value of either +1 or −1. N is the number of spins. Further, hᵢ is a local magnetic field acting on each spin. J is a matrix of coupling coefficients between spins. The matrix J is a real symmetric matrix whose diagonal components are 0. Therefore, Jᵢⱼ indicates an element in row i and column j of the matrix J. Note that the Ising model of Formula (1) is a quadratic expression for the spin, an extended Ising model (Ising model having a many-body interaction) including a third-order or higher-order term of the spin may be used as will be described later.

When the Ising model of Formula (1) is used, energy E_{Ising} can be used as an objective function, and it is possible to calculate a solution that minimizes energy E_{Ising} as much as possible. The solution of the Ising model is expressed in a format of a spin vector (s₁, s₂, . . . , s_{N}). In particular, the vector (s₁, s₂, . . . , s_{N}) having the minimum value of the energy E_{Ising} is referred to as an optimal solution. However, the solution of the Ising model to be calculated is not necessarily a strictly optimal solution. Hereinafter, a problem of obtaining an approximate solution (that is, an approximate solution in which a value of the objective function is as close as possible to the optimal value) in which the energy E_{Ising} is minimized as much as possible using the Ising model is referred to as an Ising problem.

Since the spin sᵢ in Formula (1) is a binary variable, conversion with a discrete variable (bit) used in the combinatorial optimization problem can be easily performed using Formula (1+sᵢ)/2. Therefore, it is possible to obtain a solution of the combinatorial optimization problem by converting the combinatorial optimization problem into the Ising problem and causing the Ising machine to perform calculation. A problem of obtaining a solution that minimizes a quadratic objective function having a discrete variable (bit), which takes a value of either 0 or 1, as a variable is referred to as a quadratic unconstrained binary optimization (QUBO) problem. It can be said that the Ising problem represented by Formula (1) is equivalent to the QUBO problem.

For example, a quantum annealer, a coherent Ising machine, a quantum bifurcation machine have been proposed as hardware implementations of the Ising Machine. The quantum annealer implements quantum annealing using a superconducting circuit. The coherent Ising machine uses an oscillation phenomenon of a network formed by an optical parametric oscillator. The quantum bifurcation machine uses a quantum mechanical bifurcation phenomenon in a network of a parametric oscillator with the Kerr effect. These hardware implementations have the possibility of significantly reducing a calculation time, but also have a problem that it is difficult to achieve scale-out and a stable operation.

Therefore, it is also possible to solve the Ising problem using a widely-spread digital computer. As compared with the hardware implementations using the above-described physical phenomenon, the digital computer facilitates the scale-out and the stable operation. An example of an algorithm for solving the Ising problem in the digital computer is simulated annealing (SA). A technique for performing simulated annealing at a higher speed has been developed. However, general simulated annealing is a sequential updating algorithm where each of variables is updated sequentially, and thus, it is difficult to speed up calculation processes by parallelization.

Taking the above-described problem into consideration, a simulated bifurcation algorithm, capable of solving a large-scale combinatorial optimization problem at a high speed by parallel calculation in the digital computer, has been proposed. Hereinafter, a description will be given regarding an information processing device, an information processing system, an information processing method, a storage medium, and a program for solving a combinatorial optimization problem using the simulated bifurcation algorithm.

First, an overview of the simulated bifurcation algorithm will be described.

In the simulated bifurcation algorithm, a simultaneous ordinary differential equation in (2) below is numerically solved for each of two variables xᵢ and yᵢ (i=1, 2, . . . , N), the number of each of the variables being N. Each of the N variables xᵢ corresponds to the spin sᵢ of the Ising model. On the other hand, each of the N variables yᵢ corresponds to the momentum. It is assumed that both the variables xᵢ and yᵢ are continuous variables. Hereinafter, a vector having the variable xᵢ (i=1, 2, . . . , N) as an element is referred to as a first vector, and a vector having the variable yᵢ (i=1, 2, . . . , N) as an element is referred to as a second vector.

$$\begin{matrix} [ Formula 2 ] & \\ \frac{{dx}_{i}}{dt} = \frac{\partial H}{\partial {y}_{i}} = {Dy}_{i} \\ \frac{{dy}_{i}}{dt} = - \frac{\partial H}{\partial {x}_{i}} = \{ - D + p ( t ) - {Kx}_{i}^{2} ) \} {x}_{i} - {ch}_{i} a ( t ) - c {\sum }_{j = 1}^{N} {J}_{ij} {x}_{j} & ( 2 )\end{matrix}$$

Here, H is a Hamiltonian of the following Formula (3).

$$\begin{matrix} [ Formula 3 ] & \\ H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + {ch}_{i} {x}_{i} a ( t ) + \frac{c}{2} {\sum }_{j = 1}^{N} {J}_{ij} {x}_{i} {x}_{j} ] & ( 3 )\end{matrix}$$

Note that, in (2), a Hamiltonian H′ including a potential (constraint potential function) term G(x₁, x₂, . . . , x_{N}) representing the constraint condition expressed in the following Formula (4) may be used instead of the Hamiltonian H of Formula (3). A function including not only the Hamiltonian H but also the constraint potential function is referred to as an extended Hamiltonian to be distinguished from the original Hamiltonian H.

$$\begin{matrix} [ Formula 4 ] & \\ {H}^{′} = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + {ch}_{i} {x}_{i} a ( t ) + \frac{c}{2} {\sum }_{j = 1}^{N} {J}_{ij} {x}_{i} {x}_{j} ] + G ( {x}_{1} , {x}_{2} , … , {x}_{N} ) & ( 4 )\end{matrix}$$

For example, the function G(x₁, x₂, . . . , x_{N}) derived from the constraint condition of the combinatorial optimization problem can be used. However, a method for calculating the function G(x₁, x₂, . . . , x_{N}) and a format thereof are not limited. In addition, in Formula (4), the function G (x₁, x₂, . . . , x_{N}) is added to the original Hamiltonian H. However, a method of providing the function G(x₁, x₂, . . . , x_{N}) in the extended Hamiltonian is not limited.

Values of the variables xᵢ and yᵢ (i=1, 2, . . . , N) can be repeatedly updated to obtain the spin sᵢ (i=1, 2, . . . , N) of the Ising model by calculating the time evolution of the simulated bifurcation algorithm. That is, when the time evolution is calculated, a value of the element of the first vector and a value of the element of the second vector are repeatedly updated. Here, each coefficient will be described assuming that the calculation of the time evolution is performed. However, the simulated bifurcation algorithm may be calculated using a scheme other than the time evolution.

In (2) and (3), a coefficient D corresponds to detuning. A coefficient p(t) corresponds to a pumping amplitude. When the time evolution of the simulated bifurcation algorithm is calculated, a value of the coefficient p(t) monotonically increases depending on the number of updates. An initial value of the coefficient p(t) may be set to 0. A coefficient K corresponds to a positive Kerr coefficient. As a coefficient c, a constant coefficient can be used. For example, a value of the coefficient c may be determined before execution of calculation according to the simulated bifurcation algorithm. For example, the coefficient c can be set to a value close to an inverse number of the maximum eigenvalue of the J⁽²⁾ matrix. For example, a value of c=0.5D√(N/2n) can be used. Here, n is the number of edges of a graph related to the combinatorial optimization problem. In addition, a(t) is a coefficient that increases with p(t) at the time of calculating the time evolution. For example, √(p(t)/K) can be used as a(t). Note that the vector hᵢ of the local magnetic field in (3) and (4) can be omitted.

In the case of calculating the time evolution, a solution vector having the spin sᵢ as an element can be obtained by converting the variable xᵢ which is a positive value into +1 and the variable xᵢ which is a negative value into −1 in the first vector when the value of the coefficient p(t) exceeds a predetermined value. This solution vector corresponds to the solution of the Ising problem. Note that it may be determined whether to obtain a solution vector by executing the above-described conversion based on the number of updates of the first vector and the second vector.

In the case of calculating the time evolution of the simulated bifurcation algorithm, the above-described (2) can be converted into a discrete recurrence formula using the Symplectic Euler method to obtain the solution. The following (5) represents an example of the simulated bifurcation algorithm after being converted into the recurrence formula.

$$\begin{matrix} [ Formula 5 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + p ( t + Δ t ) - {Kx}_{i}^{2} ( t + Δ t ) \} {x}_{i} ( t + Δ t ) - {ch}_{i} a ( t + Δ t ) ] Δ t - c Δ t {\sum }_{j = 1}^{N} {J}_{i , j} {x}_{j} ( t + Δ t ) & ( 5 )\end{matrix}$$

Here, t is time, and Δt is a time step (time increment). Note that time t and a time step Δt are used to indicate the correspondence relationship with the differential equation in (5). However, the time t and the time step Δt are not necessarily included as explicit parameters when actually implementing the algorithm in software or hardware. For example, if the time step Δt is 1, the time step Δt can be removed from the algorithm at the time of implementation. In a case where the time t is not included as the explicit parameter when the algorithm is implemented, xᵢ(t+Δt) may be interpreted as an updated value of xᵢ(t) in (4). That is, “t” in the above-described (4) indicates a value of the variable before update, and “t+Δt” indicates a value of the variable after update.

In the case of calculating the time evolution of the simulated bifurcation algorithm, the value of the spin sᵢ can be obtained based on the sign of the variable xᵢ after increasing the value of p(t) from the initial value (for example, 0) to a predetermined value. For example, if a signum function of sgn(xᵢ)=+1 when xᵢ>0 and sgn(xᵢ)=−1 when xᵢ<0 is used, the value of the spin sᵢ can be obtained by converting the variable xᵢ with the signum function when the value of p(t) increases to the predetermined value. As the signum function, for example, it is possible to use a function that enables sgn(xᵢ)=xᵢ/|xᵢ| when xᵢ≠0 and sgn(xᵢ)=+1 or −1 when xᵢ=0. A timing of obtaining the solution (for example, the spin sᵢ of the Ising model) of the combinatorial optimization problem is not particularly limited. For example, the solution (solution vector) of the combinatorial optimization problem may be obtained when the number of updates of the first vector and the second vector or the value of the first coefficient p becomes larger than a threshold.

In this manner, the processing circuit of the information processing device may be configured to calculate a solution by converting a first variable, which is a positive value, into a first value and converting a first variable, which is a negative value, into a second value smaller than the first value. In addition, the processing circuit may be configured to determine whether to calculate the solution based on a value of a first coefficient or the number of updates of the first vector and the second vector. Here, the first value is, for example, +1. The second value is, for example, −1. However, the first value and the second value may be other values.

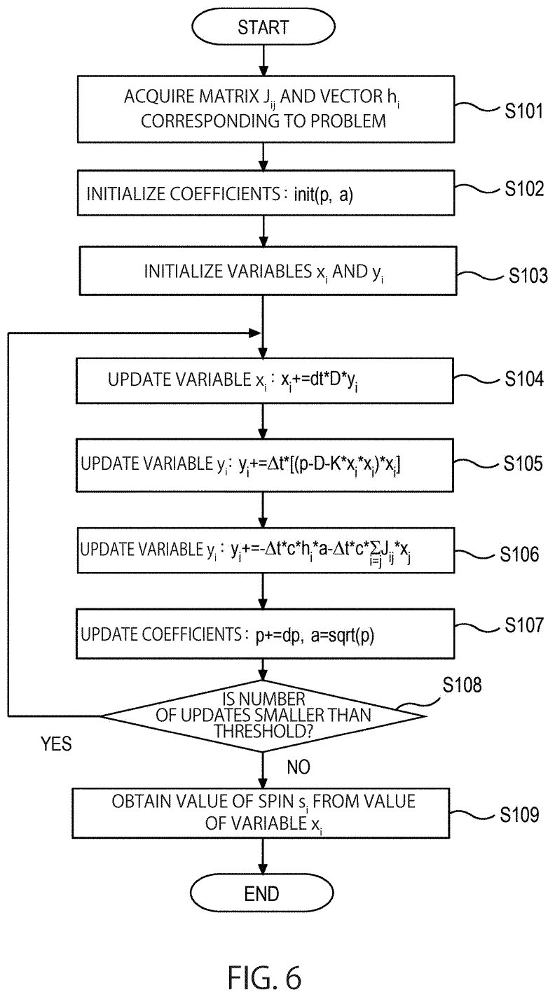

The flowchart of FIG. 6 illustrates an example of processing in the case where the solution of the simulated bifurcation algorithm is calculated by the time evolution. Hereinafter, the processing will be described with reference to FIG. 6.

First, the calculation server acquires the matrix Jᵢⱼ and the vector hᵢ corresponding to a problem from the management server 1 (step S101). Then, the calculation server initializes the coefficients p(t) and a(t) (step S102). For example, values of the coefficients p and a can be set to 0 in step S102, but the initial values of the coefficients p and a are not limited. Next, the calculation server initializes the first variable xᵢ and the second variable yᵢ (step S103). Here, the first variable xᵢ is an element of the first vector. In addition, the second variable yᵢ is an element of the second vector. In step S103, the calculation server may initialize xᵢ and yᵢ using pseudo random numbers, for example. However, a method for initializing xᵢ and yᵢ is not limited. In addition, the variables may be initialized at different timings, or at least one of the variables may be initialized a plurality of times.

Next, the calculation server updates the first vector by performing weighted addition on the element yᵢ of the second vector corresponding to the element xᵢ of the first vector (step S104). For example, Δt×D×yᵢ can be added to the variable xᵢ in step S104. Then, the calculation server updates the element yᵢ of the second vector (steps S105 and S106). For example, Δt×[(p−D—K×xᵢ×xᵢ)×xᵢ] can be added to the variable yᵢ in step S105. In step S106, −Δt×c×hᵢ×a−Δt×c×ΣJᵢⱼ×xⱼ can be further added to the variable yᵢ.

Next, the calculation server updates the values of the coefficients p and a (step S107). For example, a constant value (Δp) can be added to the coefficient p, and the coefficient a can be set to a positive square root of the updated coefficient p. However, this is merely an example of a method for updating the values of the coefficients p and a as will be described later. Then, the calculation server determines whether the number of updates of the first vector and the second vector is smaller than the threshold (step S108). When the number of updates is smaller than the threshold (YES in step S108), the calculation server executes the processes of steps S104 to S107 again. When the number of updates is equal to or larger than the threshold (NO in step S108), the spin sᵢ, which is the element of the solution vector, is obtained based on the element xᵢ of the first vector (step S109). In step S109, the solution vector can be obtained, for example, in the first vector by converting the variable xᵢ which is the positive value into +1 and the variable xᵢ which is the negative value into −1.

Note that when the number of updates is smaller than the threshold in the determination in step S108 (YES in step S108), a value of the Hamiltonian may be calculated based on the first vector, and the first vector and the value of the Hamiltonian may be stored. As a result, a user can select an approximate solution closest to the optimal solution from the plurality of first vectors.

Note that at least one of the processes illustrated in the flowchart of FIG. 6 may be executed in parallel. For example, the processes of steps S104 to S106 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation for realizing parallelization of the processes and a mode of the parallelization of the processes are not limited.

The execution order of processes of updating the variables xᵢ and yᵢ illustrated in steps S105 to S106 described above is merely an example. Therefore, the processes of updating the variables xᵢ and yᵢ may be executed in a different order. For example, the order in which the process of updating the variable xᵢ and the process of updating the variable yᵢ are executed may be interchanged. In addition, the order of sub-processing included in the process of updating each variable is not limited. For example, the execution order of the addition process included in the process of updating the variable yᵢ may be different from the example of FIG. 6. The execution order and timing of processing as a precondition for executing the process of updating each variable are also not particularly limited. For example, the calculation process of the problem term may be executed in parallel with other processes including the process of updating the variable xᵢ. The same applies to the processing in each flowchart to be described hereinafter, in that the execution order and timings of the processes of updating the variables xᵢ and yᵢ, the sub-processing included in the process of updating each variable, and the calculation process of the problem term are not limited.

### [Objective Function Including Constraint Term]

As described above, the simulated bifurcation algorithm can be calculated using the extended Hamiltonian in which the constraint potential function G(x₁, x₂, . . . , x_{N}) is included in the Hamiltonian H instead of the Hamiltonian H. Details of the function G(x₁, x₂, . . . , x_{N}) will be described later.

The function G(x₁, x₂, . . . , x_{N}) may represent one constraint condition. In addition, the function G(x₁, x₂, . . . , x_{N}) may represent a plurality of constraint conditions as will be described later. Here, gₘ(x₁, x₂, . . . , x_{N}) (m=1, 2 . . . , M) represents a function (constraint function) expressing each of M constraint conditions. In this case, the above-described function G(x₁, x₂, . . . , x_{N}) can be defined using the plurality of functions gₘ(x₁, x₂, . . . , x_{N}).

In the calculation of the optimization problem including the constraint condition, it is preferable to use the function G(x₁, x₂, . . . , x_{N}) that does not lower the accuracy and efficiency of a solving process. Therefore, the constraint condition is desirably expressed as an equality constraint such as gₘ(x₁, x₂, . . . , x_{N})=0 (m=1, 2 . . . , M). However, not all constraint conditions are expressed as equality constraints. Therefore, regarding the constraint condition, conversion of a constraint function may be performed based on the following rules (a) to (c). Here, g*ₘ(x₁, x₂, . . . , x_{N}) is a constraint function before conversion.

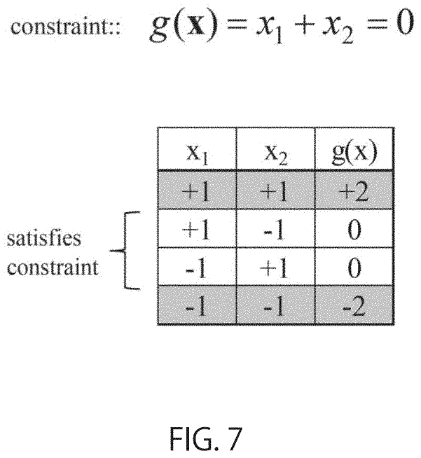

(a) In a case where a constraint condition is originally an equality constraint, such as gₘ*(x₁, x₂, . . . , x_{N})=0, gₘ(x₁, x₂, . . . , x_{N})=gₘ*(x₁, x₂, . . . , x_{N}) holds. A constraint of x₁+x₂=0 in FIG. 7 represents an example of the equality constraint. A table of FIG. 7 illustrates a condition table in the constraint of x₁+x₂=0. A row which is not grayed out in the table of FIG. 7 corresponds to a combination of variables satisfying the constraint condition.

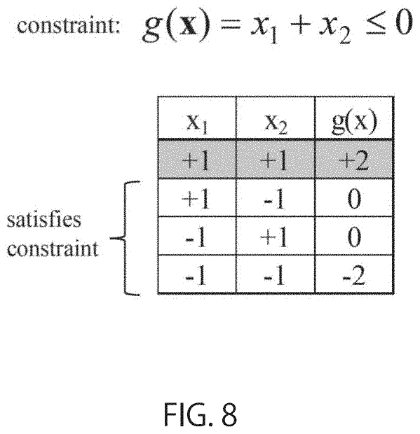

(b) In a case where an original constraint condition is an inequality constraint, such as gₘ*(x₁, x₂, . . . , x_{N})≤0, gₘ(x₁, x₂, . . . , x_{N})=max(0, gₘ*(x₁, x₂, . . . , x_{N})) can be set. Here, the function max is a function that takes a larger argument between a first argument and a second argument as a value. A constraint of xᵢ+x₂≤0 in FIG. 8 represents an example of the inequality constraint. A table of FIG. 8 illustrates a condition table in the constraint of x₁+x₂≤0. A row which is not grayed out in the table of FIG. 8 corresponds to a combination of variables satisfying the constraint condition.

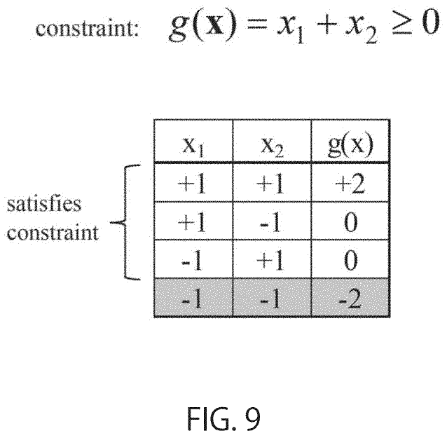

(c) In a case where an original constraint condition is an inequality constraint, such as gₘ*(x₁, x₂, . . . , x_{N})≥0, gₘ(x₁, x₂, . . . , x_{N})=min(0, gₘ*(x₁, x₂, . . . , x_{N})) can be set. Here, the function min is a function that takes a smaller argument between a first argument and a second argument as a value. A constraint of x₁+x₂≥0 in FIG. 9 represents an example of the inequality constraint. A table of FIG. 9 illustrates a condition table in the constraint of x₁+x₂≥0. A row which is not grayed out in the table of FIG. 9 corresponds to a combination of variables satisfying the constraint condition.

When the above-described conversion rules (a) to (c) are applied to the constraint condition, the extended Hamiltonian H′ expressed in the following Formula (6) can be used.

$$\begin{matrix} [ Formula 6 ] & \\ {H}^{′} ≡ {\sum }_{i = 1}^{N} [ \frac{D}{2} {x}_{i}^{2} - \frac{p ( t )}{2} {x}_{i}^{2} + \frac{K}{4} {x}_{i}^{4} + {ch}_{i} {x}_{i} a ( t ) + \frac{c}{2} {\sum }_{j = 1}^{N} {J}_{ij} {x}_{i} {x}_{j} ] + \frac{{c}_{g} ( t )}{2} {\sum }_{m = 1}^{M} {\vert {g}_{m} ( x ) \vert}^{2} & ( 6 )\end{matrix}$$

In Formula (6), c_{g}(t) is a coefficient that monotonically increases depending on the number of updates, for example.

In this case, an effect of a value of the following function (7) increases with the number of updates.

$$\begin{matrix}[ Formula 7 ] & \\ \frac{{c}_{g} ( t )}{2} {\vert {g}_{m} ( x ) \vert}^{2} & ( 7 )\end{matrix}$$

In a case where the objective function of Formula (6) is used, a process of numerically solving a simultaneous ordinary differential equation expressed in (8) below is executed for each of two variables xᵢ and yᵢ (i=1, 2, . . . , N), the number of each of the variables being N.

$$\begin{matrix} [ Formula 8 ] & \\ \frac{\partial {x}_{i}}{\partial t} = \frac{\partial {H}^{′}}{\partial {y}_{i}} = {Dy}_{i} \\ \frac{\partial {y}_{i}}{\partial t} = - \frac{\partial {H}^{′}}{\partial {x}_{i}} = - [ ( D - p ( t ) + {Kx}_{i}^{2} ) {x}_{i} + {ch}_{i} a ( t ) + c {\sum }_{j = 1}^{N} {J}_{ij} {x}_{j} ] - {c}_{g} ( t ) {\sum }_{m = 1}^{M} {g}_{m} ( x ) \frac{\partial {g}_{m}}{\partial {x}_{i}} & ( 8 )\end{matrix}$$

The above-described (8) can be converted into a discrete recurrence formula using the Symplectic Euler method to perform calculation of the simulated bifurcation algorithm. The following (9) represents an example of the simulated bifurcation algorithm after being converted into the recurrence formula.

$$\begin{matrix} [ Formula 9 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) - {Kx}_{i}^{2} \} {x}_{i} ( t + Δ t ) ] Δ t - {ch}_{i} a ( t + Δ t ) Δ t - c Δ t {\sum }_{j = 1}^{N} {J}_{i , j} {x}_{j} ( t + Δ t ) + Δ {tc}_{g} ( t ) {\sum }_{m = 1}^{M} {g}_{m} ( x ) \frac{\partial {g}_{m}}{\partial {x}_{i}} & ( 9 )\end{matrix}$$

In (9), a term of the following (10) is derived from the Ising energy. Since a format of this term is determined depending on a problem to be solved, the term is referred to as a problem term.

$$\begin{matrix}[ Formula 10 ] & \\ - {ch}_{i} a ( t + Δ t ) Δ t - c Δ t {\sum }_{j = 1}^{N} {J}_{i , j} {x}_{j} ( t + Δ t ) & ( 10 )\end{matrix}$$

On the other hand, the following term (11) in (9) corresponds to a first correction term of the variable yᵢ.

$$\begin{matrix}[ Formula 11 ] & \\ Δ {tc}_{g} {\sum }_{m = 1}^{M} {g}_{m} ( x ) \frac{\partial {g}_{m}}{\partial {x}_{i}} & ( 11 )\end{matrix}$$

A relatively small value (0 or near 0) can be used as an initial value of the coefficient c_{g}(t). As a result, it is possible to prevent the value of the term (7) from becoming too large due to the initial value set to each element xᵢ((i=1, 2, . . . , N) of the first vector, and the stability of the calculation process from being impaired. In addition, it is possible to increase the probability of finding the optimal solution or the approximate solution close thereto by performing a more global search as well as the vicinity of a specific local solution. Further, it is unnecessary to set the time step Δt of the algorithm of (9) to a small value, and thus, the calculation time can be suppressed.

For example, the coefficient c_{g}(t) defined based on the following Formula (12) can be used.

[Formula 12]

c_{g}(t)=c_{g}(0)+Δc_{g}t (12)

Here, c_{g}(0) is an initial value of the coefficient c_{g}(t). Δc_{g} is a coefficient by which the number of updates or a counter variable t is multiplied. As c_{g}(0) and Δc_{g}, positive values can be used. When the coefficient c_{g}(t) defined in (12) is used, a value of the correction term of (11) increases depending on the number of updates.

A change pattern of the coefficient c_{g}(t) depending on the initial value of the coefficient c_{g}(t) and the number of updates described here is merely an example. Therefore, the change pattern of the coefficient c_{g}(t) depending on the initial value of the coefficient c_{g}(t) and the number of updates may be different from the above.

The processing circuit of the information processing device may be configured to calculate a function (constraint term) including a product of a constraint function and a derivative obtained by differentiating the constraint function with respect to any element (first variable) of the first vector. In addition, the processing circuit may be configured to calculate the above-described product for each of a plurality of constraint conditions, and add the plurality of products to calculate the constraint term. Here, the above-described function gₘ is an example of the constraint function.

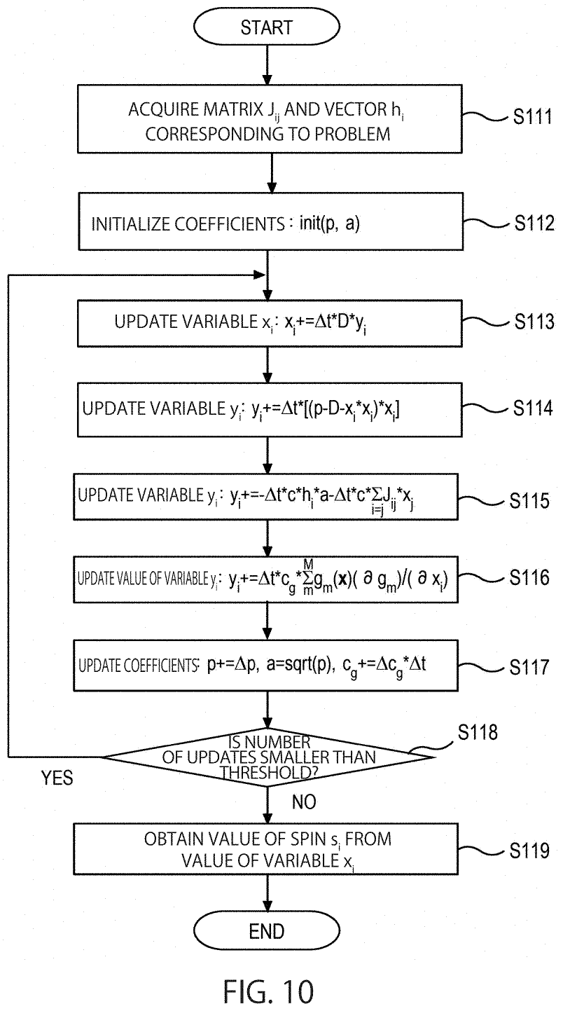

A flowchart of FIG. 10 illustrates an example of a solving process in the extended Hamiltonian including the first correction term. Hereinafter, processing will be described with reference to FIG. 10.

First, the calculation server acquires the matrix Jᵢⱼ and the vector hᵢ corresponding to a problem from the management server 1 (step S111). Then, the calculation server initializes the coefficients p(t) and a(t) (step S112). For example, values of the coefficients p and a can be set to 0 in step S112, but the initial values of the coefficients p and a are not limited. Next, the calculation server updates the element xᵢ of the first vector based on the element yᵢ of the corresponding second vector (step S113). For example, Δt×D×yᵢ can be added to the variable xᵢ in step S113. Then, the calculation server updates the element yᵢ of the second vector (steps S114 and S116). For example, Δt×[(p−D−K×xᵢ×xᵢ)×xᵢ] can be added to the variable yᵢ in step S114. In step S115, −Δt×c×hᵢ×a−Δt×c×ΣJᵢⱼ×xⱼ can be further added to the variable yᵢ. In step S116, Δt×c_{g}×Σgₘ (∂gₘ)/(∂xᵢ) can be added to the variable yᵢ.

Next, the calculation server updates the values of the coefficients p, c_{g}, and a (step S117). For example, a constant value (Δp) can be added to the coefficient p, the coefficient a can be set to a positive square root of the updated coefficient p, and Δc_{g}t can be added to the coefficient c_{g}. However, this is merely an example of a method for updating the values of the coefficients p, c_{g}, and a. Then, the calculation server determines whether the number of updates of the first vector and the second vector is smaller than a threshold (step S118). When the number of updates is smaller than the threshold (YES in step S118), the calculation server repeatedly executes the processes of steps S113 to S117. When the number of updates is equal to or larger than the threshold (NO in step S118), the spin sᵢ, which is the element of the solution vector, is obtained based on the element xᵢ of the first vector (step S119). In step S119, the solution vector can be obtained, for example, in the first vector by converting the variable xᵢ which is the positive value into +1 and the variable xᵢ which is the negative value into −1.

Note that the calculation server may calculate a value of the objective function based on the first vector and the second vector at any timing. The calculation server can store the first vector, the second vector, and the value of the objective function in the storage unit. These processes may be performed every time when the affirmative determination is made in step S118. In addition, the determination may be executed at some timings among timings at which the affirmative determination is made in step S118. Further, the above-described process may be executed at another timing. The user can determine the frequency of calculating the value of the objective function depending on an available storage area and the amount of calculation resources. Whether to continue the loop processing may be determined based on whether the number of combinations of the values of the first vector, the second vector, and the objective function stored in the storage unit exceeds a threshold at the timing of step S118. In this manner, a user can select the first vector closest to an optimal solution from the plurality of first vectors stored in the storage unit and calculate the solution vector.

Note that at least one of the processes illustrated in the flowchart of FIG. 10 may be executed in parallel. For example, the processes of steps S113 to S116 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation and an aspect of parallelization of processes are not limited.

It is possible to obtain an optimal solution that satisfies the constraint condition or an approximate solution close thereto in a relatively short time by executing the processing illustrated in the flowchart of FIG. 10.

### [Calculation Using Augmented Lagrangian Method]

The above-described Formula (6) is merely an example of the extended Hamiltonian that can reflect the constraint condition. For example, as in the following Formula (13), a term may be further added to the extended Hamiltonian in order to perform stable calculation.

$$\begin{matrix} [ Formula 13 ] & \\ {H}^{″} ≡ {\sum }_{i = 1}^{N} [ \frac{D}{2} {x}_{i}^{2} - \frac{p ( t )}{2} {x}_{i}^{2} + \frac{K}{4} {x}_{i}^{4} + {ch}_{i} {x}_{i} a ( t ) - \frac{c}{2} {\sum }_{j = 1}^{N} {J}_{ij} {x}_{i} {x}_{j} ] + \frac{{c}_{g} ( t )}{2} {\sum }_{m = 1}^{M} {\vert {g}_{m} ( x ) \vert}^{2} + {\sum }_{m = 1}^{M} {λ}_{m} {g}_{m} ( x ) & ( 13 )\end{matrix}$$

An extended Hamiltonian H″ expressed in Formula (13) includes both a penalty function (the first term of the second line) and a Lagrange function (the second term of the second line). In this manner, a method of including both the penalty function and the Lagrange function in the extended Hamiltonian is referred to as an augmented Lagrangian method.

In a case where the extended Hamiltonian of Formula (13) is used, a process of numerically solving a simultaneous ordinary differential equation expressed in (14) below is executed for each of the two variables xᵢ and yᵢ (i=1, 2, . . . , N), the number of each of the variables being N.

$$\begin{matrix} [ Formula 14 ] & \\ \frac{\partial {x}_{i}}{\partial t} = \frac{\partial {H}^{″}}{\partial {y}_{i}} = {Dy}_{i} \\ \frac{\partial {y}_{i}}{\partial t} = - \frac{\partial {H}^{″}}{\partial {x}_{i}} = {\sum }_{i = 1}^{N} [ ( D - p ( t ) + {Kx}_{i}^{2} ) {x}_{i} + {ch}_{i} {x}_{i} a ( t ) - c {\sum }_{j = 1}^{N} {J}_{ij} {x}_{j} ] - {c}_{g} ( t ) {\sum }_{m = 1}^{M} {g}_{m} ( x ) \frac{\partial {g}_{m}}{\partial {x}_{i}} + {\sum }_{m = 1}^{M} {λ}_{m} \frac{\partial {g}_{m}}{\partial {x}_{i}} & ( 14 )\end{matrix}$$

Note that a coefficient λₘ in the calculation of the simultaneous ordinary differential equation in (14) can be updated based on the following Formula (15).

$$\begin{matrix}[ Formula 15 ] & \\ \frac{\partial {λ}_{m}}{\partial t} = {c}_{g} ( t ) {g}_{m} ( {x}_{min} ) & ( 15 )\end{matrix}$$

A vector xₘᵢₙ in Formula (15) is a vector (x₁, x₂, . . . , x) which corresponds to a local solution. The local solution xₘᵢₙ can be obtained, for example, by applying a search algorithm, such as a local search method and a best-first search, to the first vector in the middle of calculation. Examples of the local search method include a negative hill-climbing method. In a case where the negative hill-climbing method is used, for example, the extended Hamiltonian H″ is partially differentiated for each variable xᵢ (i=1, 2, . . . , N) to obtain a partial derivative of (16) below.

$$\begin{matrix}[ Formula 16 ] & \\ - \frac{\partial {H}^{″}}{\partial {x}_{i}} & ( 16 )\end{matrix}$$

Then, a vector in which an evaluation value of the extended Hamiltonian H″ becomes smaller in the vicinity of the first vector is searched for based on each partial derivative. For example, a vector obtained by adding a product of the partial derivative of (16) and Δx to each element of the first vector can be used in the next iteration. Even in the next iteration, a partial derivative is calculated as above to search for a vector in which an evaluation value of the extended Hamiltonian H″ becomes smaller in the vicinity of the vector. This processing is repeated until all values of the partial derivatives of (16) become substantially 0. For example, an absolute value of the partial derivative of (16) may be compared with a threshold to determine whether to continue the iterative processing. A vector after the iterative processing (x₁, x₂, . . . , x_{N}) can be used as the local solution. The method for searching for the local solution described herein is merely an example. Therefore, the local solution may be searched for using another algorithm.

The above-described (14) and (15) can be converted into discrete recurrence formulas using the Symplectic Euler method to perform calculation of the simulated bifurcation algorithm. The following (17) represents an example of the simulated bifurcation algorithm after being converted into the recurrence formula.

$$\begin{matrix} [ Formula 17 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) - {Kx}_{i}^{2} \} {x}_{i} ( t + Δ t ) ] Δ t - {ch}_{i} a ( t + Δ t ) Δ t - c Δ t {\sum }_{j = 1}^{N} {J}_{i , j} {x}_{j} ( t + Δ t ) + Δ {tc}_{g} ( t ) {\sum }_{m = 1}^{M} {g}_{m} ( x ) \frac{\partial {g}_{m}}{\partial {x}_{i}} + Δ t {\sum }_{m = 1}^{M} {λ}_{m} ( t ) \frac{\partial {g}_{m}}{\partial {x}_{i}} \\ {λ}_{m} ( t + Δ t ) = {λ}_{m} ( t ) + Δ {tc}_{g} ( t ) {g}_{m} ( {x}_{min} ) & ( 17 )\end{matrix}$$

Even in the algorithm of (17), the coefficient c_{g} is updated. For example, the coefficient c_{g} can be updated based on Formula (12) described above.

When the constraint condition is not satisfied, a value of gₘ is relatively large. Therefore, an increase rate of the coefficient λₘ of a Lagrange term of (17) becomes high in a period in which the constraint condition is not satisfied. Therefore, an effect of the Lagrange term increases, and the first vector and the second vector can be changed in a direction in which the constraint condition is satisfied. Therefore, when the algorithm of (17) including the Lagrange function is used, the initial value of the coefficient c_{g} can be set to be smaller, or the value of the coefficient c_{g} can be more gradually increased. A gradient of the potential of the extended Hamiltonian can be prevented from becoming too large, and the calculation process can be stabilized.

The processing circuit of the information processing device may be configured to calculate a second correction term including a product of a third coefficient and a derivative obtained by differentiating the constraint condition with respect to any first variable, and add the second correction term to the second variable. In addition, the processing circuit may be configured to calculate the above-described product for each of a plurality of constraint conditions, and add the plurality of products to calculate the second correction term. Here, the above-described coefficient λₘ is an example of the third coefficient. The above-described Lagrange term is an example of the second correction term.

In addition, the processing circuit may be configured to increase an absolute value of the third coefficient depending on the number of updates. Further, the processing circuit may be configured to calculate an evaluation value of the constraint condition by substituting an element of the first vector corresponding to a local solution of an objective function (extended Hamiltonian) for the constraint condition, and add a product of the second coefficient and the evaluation value to the third coefficient. For example, the vector xₘᵢₙ calculated by the local search method can be substituted for the function gₘ to obtain the evaluation value.

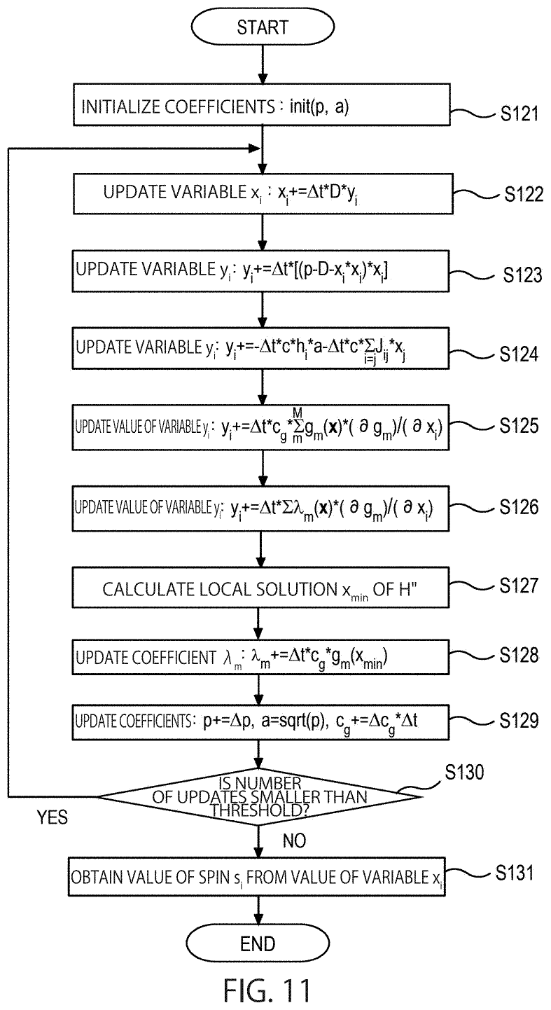

A flowchart of FIG. 11 illustrates an example of a solving process in the extended Hamiltonian further including the second correction term. Hereinafter, processing will be described with reference to FIG. 11.

First, the calculation server initializes the coefficients p(t) and a(t) (step S121). For example, values of the coefficients p and a can be set to 0 in step S121, but the initial values of the coefficients p and a are not limited. Note that it is assumed that the calculation server acquires the matrix and the vector hᵢ corresponding to the problem from the management server 1 although not illustrated in FIG. 11. Next, the calculation server updates the element xᵢ of the first vector based on the element yᵢ of the corresponding second vector (step S122). For example, Δt×D×yᵢ can be added to the variable xᵢ in step S122.

Then, the calculation server updates the element yᵢ of the second vector (steps S123 and S126). For example, Δt×[(p−D−K×xᵢ×xᵢ)×xᵢ] can be added to the variable yᵢ in step S123. In step S124, −Δt×c×hᵢ×a−Δt×c×ΣJᵢⱼ×xⱼ can be further added to the variable yᵢ. In step S125, Δt×c_{g}×(∂gₘ)/(∂xᵢ) can be added to the variable yᵢ. In step S126, Δt×Σλₘ×(∂gₘ)/(∂xᵢ) can be added to the variable yᵢ.

Then, the calculation server calculates a local solution of the extended Hamiltonian H″ (step S127). In step S127, the local solution can be calculated by the negative hill-climbing method as described above. However, the local solution may be calculated using another algorithm. Next, the coefficient λₘ is updated based on the local solution calculated in the previous step (step S128). For example, in step S128, the local solution may be substituted for the function gₘ to obtain a value of the function gₘ, and then, Δt×c_{g}×gₘ may be added to the coefficient λₘ.

Next, the calculation server updates the values of the coefficients p, c_{g}, and a (step S129). For example, a constant value (Δp) can be added to the coefficient p, the coefficient a can be set to a positive square root of the updated coefficient p, and Δc_{g}t can be added to the coefficient c_{g}. However, this is merely an example of a method for updating the values of the coefficients p, c_{g}, and a. Then, the calculation server determines whether the number of updates of the first vector and the second vector is smaller than the threshold (step S130). When the number of updates is smaller than the threshold (YES in step S130), the calculation server repeatedly executes the processes of steps S122 to S129. When the number of updates is equal to or larger than the threshold (NO in step S130), the spin sᵢ, which is the element of the solution vector, is obtained based on the element xᵢ of the first vector (step S131). In step S131, the solution vector can be obtained, for example, in the first vector by converting the variable xᵢ which is the positive value into +1 and the variable xᵢ which is the negative value into −1.

Note that the calculation server may calculate a value of the objective function based on the first vector and the second vector at any timing. The calculation server can store the first vector, the second vector, and the value of the objective function in the storage unit. These processes may be performed every time when the affirmative determination is made in step S130. In addition, the determination may be executed at some timings among timings at which the affirmative determination is made in step S130. Further, the above-described process may be executed at another timing. The user can determine the frequency of calculating the value of the objective function depending on an available storage area and the amount of calculation resources. Whether to continue the loop processing may be determined based on whether the number of combinations of the values of the first vector, the second vector, and the objective function stored in the storage unit exceeds a threshold at the timing of step S130. In this manner, a user can select the first vector closest to an optimal solution from the plurality of first vectors stored in the storage unit and calculate the solution vector.

Note that at least one of the processes illustrated in the flowchart of FIG. 11 may be executed in parallel. For example, the processes of steps S122 to S126 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation and an aspect of parallelization of processes are not limited.

It is possible to obtain an optimal solution that satisfies the constraint condition or an approximate solution close thereto in a relatively short time by executing the processing illustrated in the flowchart of FIG. 11.

### [Reduction of Calculation Amount]

In the flowchart illustrated in FIG. 11 described above, the coefficient λₘ is updated every time. However, the coefficient λₘ is not necessarily updated every time in the information processing device according to the present embodiment. For example, the update of the coefficient λₘ may be skipped in some iterations.

For example, the coefficient λₘ may be updated based on (18) below, instead of (15) described above. For example, the coefficient λₘ may be updated based on the following rule of (18) every W times (W is a positive integer).

[Formula 18]

λₘ(t+Δt)=λₘ(t)+λtZc_{g}(t)gₘ(xₘᵢₙ) (18)

In (18), z may be a fixed value or a variable. For example, a value equal to the above-described W may be set as Z. In addition, 1/(c_{g}×gₘ) may be used as Z.

The frequency at which the process of updating the coefficient λₘ is executed may vary. For example, the value of W may be proportional to 1/(c_{g}×gₘ). As a result, the update frequency of the coefficient λₘ decreases as the constraint condition is satisfied and the value of g decreases, so that the calculation amount can be suppressed.

In an iteration in which the process of updating the coefficient λₘ is skipped, the process of calculating the local solution of the extended Hamiltonian H″ may be skipped. As a result, it is possible to reduce the necessary calculation amount while maintaining the stability of the calculation process described above.

In this manner, the processing circuit of the information processing device may be configured to increase the absolute value of the third coefficient in some updates.

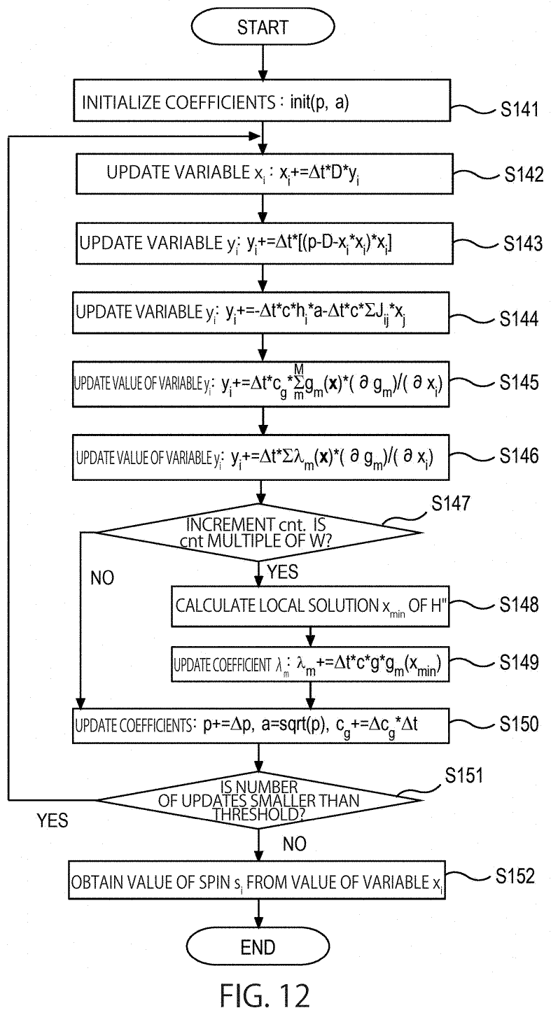

A flowchart of FIG. 12 illustrates an example of a solving process in a case where some of the processes of updating the coefficient λₘ are skipped. Hereinafter, processing will be described with reference to FIG. 12.

First, the calculation server initializes the coefficients p(t) and a(t) (step S141). For example, values of the coefficients p and a can be set to 0 in step S141, but the initial values of the coefficients p and a are not limited. A counter variable cnt to be described later can be initialized to 0. Note that it is assumed that the calculation server acquires the matrix and the vector hᵢ corresponding to the problem from the management server 1 although not illustrated in FIG. 12. Next, the calculation server updates the element xᵢ of the first vector based on the element yᵢ of the corresponding second vector (step S142). For example, Δt×D×yᵢ can be added to the variable xᵢ in step S142.

Then, the calculation server updates the element yᵢ of the second vector (steps S142 and S146). For example, Δt×[(p−D−K×xᵢ×xᵢ)×xᵢ] can be added to the variable yᵢ in step S143. In step S144, −Δt×c×hᵢ×a−Δt×c×ΣJᵢⱼ×xⱼ can be further added to the variable yᵢ. In step S145, Δt×c_{g}×Σgₘ (∂gₘ)/(∂xᵢ) can be added to the variable yᵢ. In step S146, Δt×Σλₘ×(∂gₘ)/(∂xᵢ) can be added to the variable yᵢ.

Then, the calculation server increments the counter variable cnt and determines whether the counter variable cnt is a multiple of W (S147). When the counter variable cnt is not a multiple of W (NO in S147), the calculation server updates values of the coefficients p, c_{g}, and a (step S150). For example, a constant value (Δp) can be added to the coefficient p, the coefficient a can be set to a positive square root of the updated coefficient p, and Δc_{g}t can be added to the coefficient c_{g}. However, this is merely an example of a method for updating the values of the coefficients p, c_{g}, and a.

When the counter variable cnt is a multiple of W (YES in S147), the calculation server calculates a local solution of the extended Hamiltonian H″ (step S148). In step S148, the local solution can be calculated by the negative hill-climbing method as described above. However, the local solution may be calculated using another algorithm. Next, the coefficient λₘ is updated based on the local solution calculated in the previous step (step S149). For example, in step S149, the local solution may be substituted for the function gₘ to obtain a value of the function gₘ, and then, Δt×c_{g}×gₘ may be added to the coefficient λₘ. After the process of step S149, the processing proceeds to the process of step S150 described above.

After the process of step S150, the calculation server determines whether the number of updates of the first vector and the second vector is smaller than the threshold (step S151). When the number of updates is smaller than the threshold (YES in step S151), the calculation server executes the processes of step S142 and the subsequent steps again. When the number of updates is equal to or larger than the threshold (NO in step S151), the spin sᵢ, which is the element of the solution vector, is obtained based on the element xᵢ of the first vector (step S152). In step S152, the solution vector can be obtained, for example, in the first vector by converting the variable xᵢ which is the positive value into +1 and the variable xᵢ which is the negative value into −1.

Note that the calculation server may calculate a value of the objective function based on the first vector and the second vector at any timing. The calculation server can store the first vector, the second vector, and the value of the objective function in the storage unit. These processes may be performed every time when the affirmative determination is made in step S151. In addition, the determination may be executed at some timings among timings at which the affirmative determination is made in step S151. Further, the above-described process may be executed at another timing. The user can determine the frequency of calculating the value of the objective function depending on an available storage area and the amount of calculation resources. Whether to continue the loop processing may be determined based on whether the number of combinations of the values of the first vector, the second vector, and the objective function stored in the storage unit exceeds a threshold at the timing of step S151. In this manner, a user can select the first vector closest to an optimal solution from the plurality of first vectors stored in the storage unit and calculate the solution vector.

Note that at least one of the processes illustrated in the flowchart of FIG. 12 may be executed in parallel. For example, the processes of steps S142 to S146 may be executed in parallel such that at least some of the N elements included in each of the first vector and the second vector are updated in parallel. For example, the processes may be performed in parallel using a plurality of calculation servers. The processes may be performed in parallel by a plurality of processors. However, an implementation and an aspect of parallelization of processes are not limited.

It is possible to obtain the optimal solution that satisfies the constraint condition or the approximate solution close thereto in a relatively short time while suppressing the calculation amount by executing the processing illustrated in the flowchart of FIG. 12.

Hereinafter, examples of the information processing system, the information processing method, the storage medium, and the program according to the present embodiment will be described.

The information processing system may include a storage device and an information processing device. The storage device is configured to store, for example, a first variable which is an element of a first vector and a second variable which is an element of a second vector. The information processing device is configured to, for example, update the first variable based on the corresponding second variable; weight the first variable with a first coefficient and add the weighted first variable to the corresponding second variable; calculate a problem term using the plurality of first variables; add the problem term to the second variable; calculate a first correction term including a product of a constraint term and a second coefficient; add the first correction term to the second variable; and increase absolute values of the first coefficient and the second coefficient depending on the number of updates. Here, the constraint term may be based on a constraint function representing a constraint condition, and have the first variable as an argument.

In addition, the information processing system may include a plurality of the information processing devices. Each of the information processing devices may be configured to update at least a part of the first vector and at least a part of the second vector in parallel.

For example, a first vector which has a first variable as an element and a second vector which has a second variable corresponding to the first variable as an element are repeatedly updated in an information processing method. For example, the information processing method may include: a step of updating the first variable based on the corresponding second variable; a step of weighting the first variable with a first coefficient and adding the weighted first variable to the corresponding second variable; a step of calculating a problem term using the plurality of first variables; a step of adding the problem term to the second variable; a step of calculating a constraint term which is based on a constraint condition and has the first variable as an argument; a step of calculating a first correction term including a product of a second coefficient and the constraint term; a step of adding the first correction term to the second variable; and a step of increasing absolute values of the first coefficient and the second coefficient depending on the number of updates. In addition, a program may cause a computer to execute the steps of the above-described information processing method. Further, a storage medium may be a non-transitory computer-readable storage medium that stores the program.

### [Calculation Including Term of Many-Body Interaction]

It is also possible to solve a combinatorial optimization problem having a third-order or higher-order objective function by using the simulated bifurcation algorithm. A problem of obtaining a combination of variables that minimizes the third-order or higher-order objective function, which has a binary variable as a variable, is called a higher-order binary optimization (HOBO) problem. In a case of handling the HOBO problem, the following Formula (19) can be used as an energy formula in an Ising model extended to the higher order.

$$\begin{matrix} [ Formula 19 ] & \\ {E}_{HOBO} = {\sum }_{i = 1}^{N} {J}_{i}^{( 1 )} {s}_{i} + \frac{1}{2} {\sum }_{i = 1}^{N} {\sum }_{j = 1}^{N} {J}_{i , j}^{( 2 )} {s}_{i} {s}_{j} + \frac{1}{3 !} {\sum }_{i = 1}^{N} {\sum }_{j = 1}^{N} {\sum }_{k = 1}^{N} {J}_{i , j , k}^{( 3 )} {s}_{i} {s}_{j} {s}_{k} + … & ( 19 )\end{matrix}$$

Here, J⁽ⁿ⁾ is an n-rank tensor, and is obtained by generalizing the matrix J of the local magnetic field hᵢ and a coupling coefficient of Formula (1). For example, a tensor J⁽¹⁾ corresponds to a vector of the local magnetic field hᵢ. In the n-rank tensors J⁽ⁿ⁾, when a plurality of indices have the same value, values of elements are 0. Although terms up to a third-order term are illustrated in Formula (15), but a higher-order term can also be defined in the same manner as in Formula (19). Formula (19) corresponds to the energy of the Ising model including a many-body interaction.

Note that both QUBO and HOBO can be said to be a type of polynomial unconstrained binary optimization (PUBO). That is, a combinatorial optimization problem having a second-order objective function in PUBO is QUBO. In addition, it can be said that a combinatorial optimization problem having a third-order or higher-order objective function in PUBO is HOBO.

In a case where the HOBO problem is solved using the simulated bifurcation algorithm, the Hamiltonian H of Formula (3) described above may be replaced with the Hamiltonian H of the following Formula (20).

$$\begin{matrix} [ Formula 20 ] & \\ H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + c ( {J}_{i}^{( 1 )} {x}_{i} α ( t ) + \frac{1}{2} {\sum }_{j = 1}^{N} {J}_{i , j}^{( 2 )} {x}_{i} {x}_{j} + \frac{1}{3 !} {\sum }_{j = 1}^{N} {\sum }_{k = 1}^{N} {J}_{i , j , k}^{( 3 )} {x}_{i} {x}_{j} {x}_{k} + … ) ] \\ {H}_{Ising} = {\sum }_{i = 1}^{N} [ {J}_{i}^{( 1 )} {x}_{i} α ( t ) + \frac{1}{2} {\sum }_{j = 1}^{N} {J}_{i , j}^{( 2 )} {x}_{i} {x}_{j} + \frac{1}{3 !} {\sum }_{j = 1}^{N} {\sum }_{k = 1}^{N} {J}_{i , j , k}^{( 3 )} {x}_{i} {x}_{j} {x}_{k} + … ] & ( 20 )\end{matrix}$$

In addition, a problem term expressed by the following Formula (21) is derived from Formula (20).

$$\begin{matrix}[ Formula 21 ] & \\ {z}_{i} = \frac{\partial {H}_{Ising}}{\partial {x}_{i}} = {J}_{i}^{( 1 )} α ( t ) + {\sum }_{j = 1}^{N} {J}_{i , j}^{( 2 )} {x}_{j} + {\sum }_{j = 1}^{N} {\sum }_{k = 1}^{N} {J}_{i , j , k}^{( 3 )} {x}_{j} {x}_{k} + … & ( 21 )\end{matrix}$$

The problem term zᵢ of (21) takes a format in which the second expression of (20) is partially differentiated with respect to any variable xᵢ (element of the first vector). The partially differentiated variable xᵢ differs depending on an index i. Here, the index i of the variable xᵢ corresponds to an index designating an element of the first vector and an element of the second vector.

In a case where calculation including the term of the many-body interaction is performed, the recurrence formula of (17) described above is replaced with the following recurrence formula of (22).

$$\begin{matrix} [ Formula 22 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) - {Kx}_{i}^{2} \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} {x}_{j} ( t + Δ t ) + {\sum }_{j = 1}^{N} {\sum }_{k = 1}^{N} {J}_{i , j , k}^{( 3 )} {x}_{j} ( t + Δ t ) {x}_{k} ( t + Δ t ) + … ) + Δ {tc}_{g} ( t ) {\sum }_{m = 1}^{M} {g}_{m} ( x ) \frac{\partial {g}_{m}}{\partial {x}_{i}} + Δ t {\sum }_{m = 1}^{M} {λ}_{m} ( t ) \frac{\partial {g}_{m}}{\partial {x}_{i}} \\ {λ}_{m} ( t + Δ t ) = {λ}_{m} ( t ) + Δ {tc}_{g} ( t ) {g}_{m} ( {x}_{min} ) & ( 22 )\end{matrix}$$

(22) corresponds to a further generalized recurrence formula of (17). Similarly, the term of the many-body interaction may be used in the recurrence formula of (9) described above.

The problem terms described above are merely examples of a problem term that can be used by the information processing device according to the present embodiment. Therefore, a format of the problem term used in the calculation may be different from these.

### Modified Example of Algorithm

Here, a modified example of the simulated bifurcation algorithm will be described. For example, various modifications may be made to the above-described simulated bifurcation algorithm for the purpose of reducing an error or reducing a calculation time.

For example, in order to reduce an error in calculation, additional processing may be executed at the time of updating the element of the first vector. For example, when an absolute value of the element xᵢ of the first vector becomes larger than 1 by the update, a value of the element xᵢ of the first vector is replaced with sgn(xᵢ). That is, when xᵢ>1 is satisfied by the update, the value of the variable xᵢ is set to 1. In addition, when xᵢ<−1 is satisfied by the update, the value of the variable xᵢ is set to −1. As a result, it is possible to approximate the spin sᵢ with higher accuracy using the variable xᵢ. Since such processing is included, the algorithm is equivalent to a physical model of an N particles having a wall at positions of xᵢ=±1. More generally speaking, an arithmetic circuit may be configured to set the first variable, which has a value smaller than a second value, to the second value, and set the first variable, which has a value larger than a first value, to the first value.

Further, when xᵢ>1 is satisfied by the update, the variable yᵢ corresponding to the variable xᵢ may be multiplied by a coefficient rf. For example, when the coefficient rf of −1<r≤0 is used, the above wall becomes a wall of the reflection coefficient rf. In particular, when the coefficient rf of rf=0 is used, the algorithm is equivalent to a physics model with a wall causing completely inelastic collisions at positions of xᵢ=±1. More generally speaking, the arithmetic circuit may be configured to update a second variable which corresponds to the first variable having the value smaller than the first value or a second variable which corresponds to the first variable larger than the second value, to a value obtained by multiplying the original second variable by a second coefficient. For example, the arithmetic circuit may be configured to update the second variable which corresponds to the first variable having the value smaller than −1 or the second variable which corresponds to the first variable having the value larger than 1, to the value obtained by multiplying the original second variable by the second coefficient. Here, the second coefficient corresponds to the above-described coefficient rf.

Note that the arithmetic circuit may set a value of the variable yᵢ corresponding to the variable xᵢ to a pseudo random number when xᵢ>1 is satisfied by the update. For example, a random number in the range of [−0.1, 0.1] can be used. That is, the arithmetic circuit may be configured to set a value of the second variable which corresponds to a first variable having the value smaller than the second value or a value of the second variable which corresponds to the first variable having the value larger than the first value, to the pseudo random number.

If the update process is executed so as to suppress |xᵢ|>1 as described above, the value of xᵢ does not diverge even if the non-linear term K×xᵢ² in (5), (9), and (22) is removed. Therefore, it is possible to use an algorithm illustrated in (23) below.

$$\begin{matrix} [ Formula 23 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} {x}_{j} ( t + Δ t ) + {\sum }_{j = 1}^{N} {\sum }_{k = 1}^{N} {J}_{i , j , k}^{( 3 )} {x}_{j} ( t + Δ t ) {x}_{k} ( t + Δ t ) + … ) + Δ {tc}_{g} ( t ) {\sum }_{m = 1}^{M} {g}_{m} ( x ) \frac{\partial {g}_{m}}{\partial {x}_{i}} + Δ t {\sum }_{m = 1}^{M} {λ}_{m} ( t ) \frac{\partial {g}_{m}}{\partial {x}_{i}} \\ {λ}_{m} ( t + Δ t ) = {λ}_{m} ( t ) + Δ {tc}_{g} ( t ) {g}_{m} ( {x}_{min} ) & ( 23 )\end{matrix}$$

In the algorithm of (23), a continuous variable x is used in the problem term instead of a discrete variable. Therefore, there is a possibility that an error from the discrete variable used in the original combinatorial optimization problem occurs. In order to reduce this error, a value sgn(x) obtained by converting the continuous variable x by a signum function can be used instead of the continuous variable x in the calculation of the problem term as in (24) below.

$$\begin{matrix} [ Formula 24 ] & \\ {x}_{i} ( t + Δ t ) = {x}_{i} ( t ) + {Dy}_{i} ( t ) Δ t \\ {y}_{i} ( t + Δ t ) = {y}_{i} ( t ) + [ \{ - D + {p}^{( m 1 )} ( t + Δ t ) \} {x}_{i} ( t + Δ t ) ] Δ t - c Δ t ( {J}_{i}^{( 1 )} α ( t + Δ t ) + {\sum }_{j = 1}^{N} {J}_{i , j}^{( 2 )} sgn ( {x}_{j} ( t + Δ t ) ) + {\sum }_{j = 1}^{N} {\sum }_{k = 1}^{N} {J}_{i , j , k}^{( 3 )} sgn ( {x}_{j} ( t + Δ t ) ) sgn ( {x}_{k} ( t + Δ t ) ) + … ) + Δ {tc}_{g} ( t ) {\sum }_{m = 1}^{M} {g}_{m} ( x ) \frac{\partial {g}_{m}}{\partial {x}_{i}} + Δ t {\sum }_{m = 1}^{M} {λ}_{m} ( t ) \frac{\partial {g}_{m}}{\partial {x}_{i}} \\ {λ}_{m} ( t + Δ t ) = {λ}_{m} ( t ) + Δ {tc}_{g} ( t ) {g}_{m} ( {x}_{min} ) & ( 24 )\end{matrix}$$

In (24), sgn(x) corresponds to the spin s.

In (24), the coefficient a of a term including the first-rank tensor in the problem term may be a constant (for example, α=1). In an algorithm of (24), the product of spins appearing in the problem term always takes any value of −1 or 1, and thus, it is possible to prevent the occurrence of an error due to the product operation when the HOMO problem having the higher-order objective function is handled. As in the algorithm of (24) described above, data calculated by the calculation server may further include a spin vector (s₁, s₂, . . . , s_{N}) having the variable sᵢ (i=1, 2, . . . , N) as an element. The spin vector can be obtained by converting each element of the first vector by a signum function.

### Example of Parallelization of Variable Update Processes

Hereinafter, an example of parallelization of variable update processes at the time of calculation of the simulated bifurcation algorithm will be described.

First, an example in which the simulated bifurcation algorithm is implemented in a PC cluster will be described. The PC cluster is a system that connects a plurality of computers and realizes calculation performance that is not obtainable by one computer. For example, the information processing system 100 illustrated in FIG. 1 includes a plurality of calculation servers and processors, and can be used as the PC cluster. For example, the parallel calculation can be executed even in a configuration in which memories are arranged to be distributed in a plurality of calculation servers as in the information processing system 100 by using a message passing interface (MPI) in the PC cluster. For example, the control program 14E of the management server 1, the calculation program 34B and the control program 34C of each of the calculation servers can be implemented using the MPI.

In a case where the number of processors used in the PC cluster is Q, it is possible to cause each of the processors to calculate L variables among the variables xᵢ included in the first vector (x₁, x₂, . . . , x_{N}). Similarly, it is possible to cause each of the processors to calculate L variables among the variables yᵢ included in the second vector (yᵢ, y₂, . . . , y_{N}). That is, processors #j (j=1, 2, . . . , Q) calculate variables {xₘ|m=(j−1)L+1, (j−1)L+2, . . . , jL} and {yₘ|m=(j−1)L+1, (j−1)L+2, . . . , jL}. In addition, a tensor J⁽ⁿ⁾ expressed in the following (25), necessary for the calculation of {yₘ|m=(j−1)L+1, (j−1)L+2, . . . , jL} by the processors #j, is stored in a storage area (for example, a register, a cache, a memory, or the like) accessible by the processors #j.

[Formula 25]

{Jₘ⁽¹⁾|m=(i−1)L+1, . . . iL}

{J_{m,j}⁽²⁾|m=(i−1)L+1, . . . iL;j=1, . . . N}

{J_{m,j,k}⁽³⁾|m=(i−1)L+1, . . . iL;j=1, . . . N;k=1, . . . N}, . . . (25)

Here, the case where each of the processors calculates the constant number of variables of each of the first vector and the second vector has been described. However, the number of variables of the first vector and the second vector to be calculated may be different depending on the processor. For example, in a case where there is a performance difference depending on a processor implemented in a calculation server, the number of variables to be calculated can be determined depending on the performance of the processor.

Values of all the components of the first vector (x₁, x₂, . . . , x_{N}) are required in order to update the value of the variable yᵢ. The conversion into a binary variable can be performed, for example, by using the signum function sgn( ). Therefore, the values of all the components of the first vector (x₁, x₂, . . . , x_{N}) can be shared by the Q processors using the Allgather function. Although it is necessary to share the values between the processors regarding the first vector (x₁, x₂, . . . , x_{N}), but it is not essential to share values between the processors regarding the second vector (y₁, y₂, . . . , y_{N}) and the tensor J⁽ⁿ⁾. The sharing of data between the processors can be realized, for example, by using inter-processor communication or by storing data in a shared memory.

The processor #j calculates a value of the problem term {zₘ|m=(j−1)L+1, (j−1)L+2, . . . , jL}. Then, the processor #j updates the variable {yₘ|m=(j−1)L+1, (j−1)L+2, . . . , jL} based on the calculated value of the problem term {{zₘ|m=(j−1)L+1, (j−1)L+2, . . . , jL}.

As illustrated in the above-described respective formulas, the calculation of the vector (z₁, z₂, . . . , z_{N}) of the problem term requires the product-sum operation including the calculation of the product of the tensor J(n) and the vector (x₁, x₂, . . . , x_{N}). The product-sum operation is processing with the largest calculation amount in the above-described algorithm, and can be a bottleneck in improving the calculation speed. Therefore, the product-sum operation is distributed to Q=N/L processors and executed in parallel in the implementation of the PC cluster, so that the calculation time can be shortened.

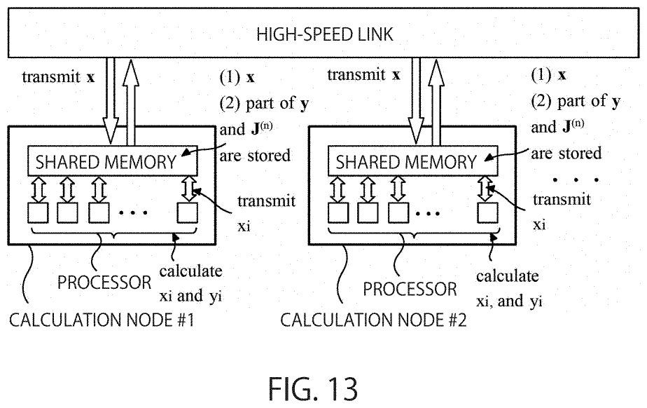

FIG. 13 schematically illustrates an example of a multi-processor configuration. A plurality of calculation nodes in FIG. 13 correspond to, for example, the plurality of calculation servers of the information processing system 100. In addition, a high-speed link of FIG. 13 corresponds to, for example, the interconnection between the calculation servers formed by the cables 4a to 4c and the switch 5 of the information processing system 100. A shared memory in FIG. 13 corresponds to, for example, the shared memory 32. Processors in FIG. 13 correspond to, for example, the processors 33A to 33D of the respective calculation servers. Note that FIG. 13 illustrates the plurality of calculation nodes, but the use of a configuration of a single calculation node is not precluded.

FIG. 13 illustrates data arranged in each of components and data transferred between the components. In each of the processors, values of the variables xᵢ and yᵢ are calculated. In addition, the variable xᵢ is transferred between the processor and the shared memory. In the shared memory of each of the calculation nodes, for example, the first vector (x₁, x₂, . . . , x_{N})), L variables of the second vector (y₁, y₂, . . . , y_{N}), and some of the tensors J⁽ⁿ⁾ are stored. Then, for example, the first vector (x₁, x₂, . . . , x_{N}) is transferred in the high-speed link connecting the calculation nodes. In a case where the Allgather function is used, all elements of the first vector (x₁, x₂, . . . , x_{N}) are required in order to update the variable yᵢ in each of the processors.

Note that the arrangement and transfer of data illustrated in FIG. 13 are merely examples. A data arrangement method, a transfer method, and a parallelization method in the PC cluster are not particularly limited.

In addition, the simulated bifurcation algorithm may be calculated using a graphics processing unit (GPU).

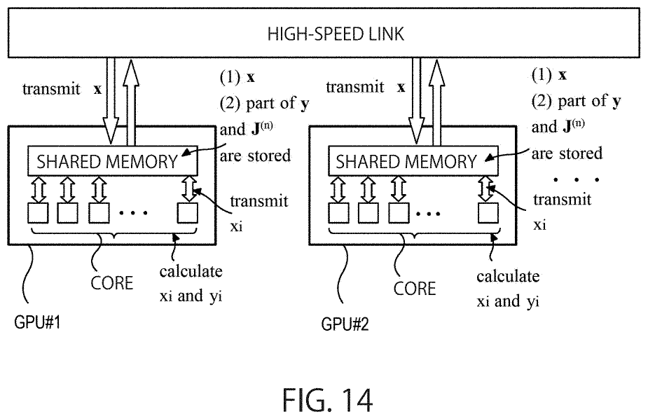

FIG. 14 schematically illustrates an example of a configuration using the GPU. FIG. 14 illustrates a plurality of GPUs connected to each other by a high-speed link. Each GPU is equipped with a plurality of cores capable of accessing a shared memory. In addition, the plurality of GPUs are connected via the high-speed link to form a GPU cluster in the configuration example of FIG. 14. For example, if the GPUs are mounted on the respective calculation servers in FIG. 1, the high-speed link corresponds to the interconnection between the calculation servers formed by the cables 4a to 4c and the switch 5. Note that the plurality of GPUs are used in the configuration example of FIG. 14, but parallel calculation can be executed even in a case where one GPU is used. That is, each of the GPUs of FIG. 14 may perform the calculation corresponding to each of the calculation nodes of FIG. 13. That is, the processor of the information processing device (calculation server) may be a core of a graphics processing unit (GPU).

In the GPU, the variables xᵢ and yᵢ and the tensor J⁽ⁿ⁾ are defined as device variables. The GPUs can calculate the product of the tensor J⁽ⁿ⁾ necessary to update the variable yᵢ and the first vector (x₁, x₂, . . . , x_{N}) in parallel by a matrix vector product function. Note that the product of the tensor and the vector can be obtained by repeatedly executing the matrix vector product operation. In addition, it is possible to parallelize the processes by causing each thread to execute a process of updating the i-th element (xᵢ, yᵢ) for a portion other than the product-sum operation in the calculation of the first vector (x₁, x₂, . . . , x_{N}) and the second vector (y₁, y₂, . . . , y_{N}).

### [Overall Processing for Solving Combinatorial Optimization Problem]

The following describes overall processing executed to solve a combinatorial optimization problem using the simulated bifurcation algorithm.

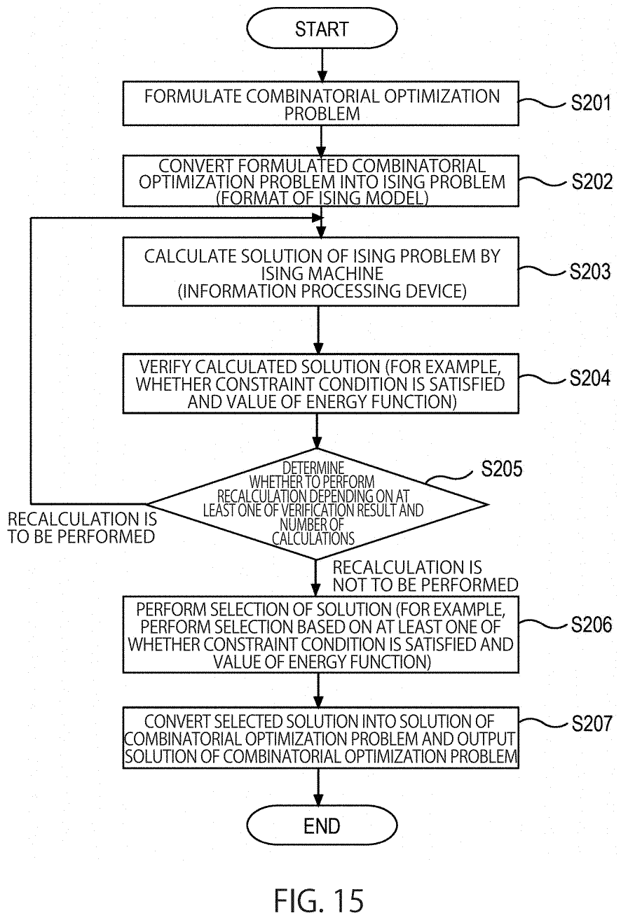

A flowchart of FIG. 15 illustrates an example of the overall processing executed to solve the combinatorial optimization problem. Hereinafter, processing will be described with reference to FIG. 15.

First, the combinatorial optimization problem is formulated (step S201). Then, the formulated combinatorial optimization problem is converted into an Ising problem (a format of an Ising model) (step S202). Next, a solution of the Ising problem is calculated by an Ising machine (information processing device) (step S203). Then, the calculated solution is verified (step S204). For example, in step S204, whether a constraint condition has been satisfied is confirmed. Further, in step S204, whether the obtained solution is the optimal solution or the approximate solution close thereto may be confirmed by referring to the value of the energy function (Hamiltonian).

Then, it is determined whether recalculation is to be performed depending on at least one of the verification result or the number of calculations in step S204 (step S205). When it is determined that the recalculation is to be performed (YES in step S205), the processes in steps S203 and S204 are executed again. On the other hand, when it is determined that the recalculation is not to be performed (NO in step S205), a solution is selected (step S206). For example, in step S206, selection can be performed based on at least one of whether the constraint condition is satisfied or the value of the energy function. Note that the process of step S206 may be skipped when a plurality of solutions are not calculated. Finally, the selected solution is converted into a solution of the combinatorial optimization problem, and the solution of the combinatorial optimization problem is output (step S207).

When the information processing device, the information processing system, the information processing method, the storage medium, and the program described above are used, the solution of the combinatorial optimization problem can be calculated within the practical time. As a result, it becomes easier to solve the combinatorial optimization problem, and it is possible to promote social innovation and progress in science and technology.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing device comprising:
a storage unit configured to store a first variable which is an element of a first vector and a second variable which is an element of a second vector; and
a processing circuit configured to update the first variable based on the second variable, which corresponds to the first variable, weight the first variable with a first coefficient and add the weighted first variable to the corresponding second variable, calculate a problem term using a plurality of the first variables, add the problem term to the second variable, calculate a first correction term including a product of a constraint term and a second coefficient, add the first correction term to the second variable, and increase absolute values of the first coefficient and the second coefficient depending on a number of updates,
wherein the constraint term is based on a constraint function representing a constraint condition and has the first variable as an argument.

2. The information processing device according to claim 1, wherein
the processing circuit is configured to calculate the constraint term including a product of the constraint function and a derivative obtained by differentiating the constraint function with respect to any of the first variables.

3. The information processing device according to claim 2, wherein
the processing circuit is configured to calculate the product for each of a plurality of the constraint conditions, and add a plurality of the products to calculate the constraint term.

4. The information processing device according to claim 1, wherein
the processing circuit is configured to calculate a second correction term including a product of a third coefficient and a derivative obtained by differentiating the constraint condition with respect to any of the first variables, and add the second correction term to the second variable.

5. The information processing device according to claim 4, wherein
the processing circuit is configured to calculate the product for each of a plurality of the constraint conditions and add a plurality of the products to calculate the second correction term.

6. The information processing device according to claim 4, wherein
the processing circuit is configured to increase an absolute value of the third coefficient depending on a number of updates.

7. The information processing device according to claim 6, wherein
the processing circuit is configured to increase an absolute value of the third coefficient in some updates.

8. The information processing device according to claim 6, wherein
the processing circuit is configured to calculate an evaluation value of the constraint function by substituting the first variable corresponding to a local solution of an objective function for the constraint function, and add a product of the second coefficient and the evaluation value to the third coefficient.

9. The information processing device according to claim 1, wherein
the problem term calculated by the processing circuit is based on an Ising model.

10. The information processing device according to claim 9, wherein
the problem term calculated by the processing circuit includes a many-body interaction.

11. The information processing device according to claim 1, comprising
a plurality of the processing circuits,
wherein the respective processing circuits are configured to update at least a part of the first vector and at least a part of the second vector in parallel.

12. The information processing device according to claim 1, wherein
the processing circuit is configured to calculate a solution by converting the first variable, which is a positive value, into a first value and converting the first variable, which is a negative value, into a second value smaller than the first value.

13. The information processing device according to claim 12, wherein
the processing circuit is configured to determine whether to calculate the solution based on a value of the first coefficient or a number of updates of the first vector and the second vector.

14. An information processing system comprising:
a storage device configured to store a first variable which is an element of a first vector and a second variable which is an element of a second vector; and
an information processing device configured to update the first variable based on the second variable, which corresponds to the first variable, weight the first variable with a first coefficient and add the weighted first variable to the corresponding second variable, calculate a problem term using a plurality of the first variables, add the problem term to the second variable, calculate a first correction term including a product of a constraint term and a second coefficient, add the first correction term to the second variable, and increase absolute values of the first coefficient and the second coefficient depending on a number of updates,
wherein the constraint term is based on a constraint function representing a constraint condition and has the first variable as an argument.

15. The information processing system according to claim 14, comprising
a plurality of the information processing devices,
wherein the respective information processing devices are configured to update at least a part of the first vector and at least a part of the second vector in parallel.

16. An information processing method for repeatedly updating a first vector, which has a first variable as an element, and a second vector, which has a second variable corresponding to the first variable as an element, the information processing method comprising:
a step of updating the first variable based on the corresponding second variable;
a step of weighting the first variable with a first coefficient and adding the weighted first variable to the corresponding second variable;
a step of calculating a problem term using a plurality of the first variables;
a step of adding the problem term to the second variable;
a step of calculating a constraint term which is based on a constraint condition and has the first variable as an argument;
a step of calculating a first correction term including a product of a second coefficient and the constraint term;
a step of adding the first correction term to the second variable; and
a step of increasing absolute values of the first coefficient and the second coefficient depending on a number of updates.

17. A non-transitory computer-readable storage medium storing a program for causing a computer to repeatedly update a first vector, which has a first variable as an element, and a second vector, which has a second variable corresponding to the first variable as an element, the program causing the computer to execute:
a step of updating the first variable based on the corresponding second variable;
a step of weighting the first variable with a first coefficient and adding the weighted first variable to the corresponding second variable;
a step of calculating a problem term using a plurality of the first variables;
a step of adding the problem term to the second variable;
a step of calculating a constraint term which is based on a constraint condition and has the first variable as an argument;
a step of calculating a first correction term including a product of a second coefficient and the constraint term;
a step of adding the first correction term to the second variable; and
a step of increasing absolute values of the first coefficient and the second coefficient depending on a number of updates.
